(19) United States
(12) Patent Application Publication
(10) Pub. No.: US 2019/0215385 A1
(43) Pub. Date: Jul. 11, 2019

(54) Packet Replication Over Dynamically Managed Bonded Tunnels

(71) Applicants: Randall Paul Joseph Ethier, Burke, VA (US); Anatoly Yakovlevich Rodionov, Reston, VA (US); Jordan Steven Feldman, Cupertino, CA (US)

(72) Inventors: Randall Paul Joseph Ethier, Burke, VA (US); Anatoly Yakovlevich Rodionov, Reston, VA (US); Jordan Steven Feldman, Cupertino, CA (US)

(73) Assignee: nexVortex, Inc., Herndon, VA (US)

(21) Appl. No.: 16/241,557

(22) Filed: Jan. 7, 2019

Related U.S. Application Data
(60) Provisional application No. 62/615,567, filed on Jan. 10, 2018.

(51) Int. Cl. H04L 29/08; H04L 12/707; H04L 12/721; H04L 29/06; H04L 12/801

(52) U.S. Cl. CPC H04L 69/324; H04L 45/24; H04L 47/34; H04L 45/124; H04L 69/22; H04L 45/123

(57) ABSTRACT

Disclosed herein are systems and methods for sending packet replication over sets of bonded diverse packet paths with packet merge and deduplication at the bonded packet paths' egress thereby providing reduced packet loss, latency, and jitter while simultaneously providing high availability. Collectively these sets of bonded packet paths conveying replicated packets compose a virtual overlay network spanning diverse paths, and potentially diverse providers, and diverse network technologies. A control system continuously monitors the reachability and quality of synthetic or both synthetic traffic and bonded packet path traffic across all possible paths as input to the control system that dynamically while taking into account path cost manages the sets of bonded packet paths. As a function of changing conditions across the employed and available alternate paths the control system inserts and/or removes bonded paths on a bonded paths set basis and/or by modifying the packet replication instructions on a bonded paths set basis to continuously and optimally minimize packet loss and latency while maintaining the high level of availability.

### CROSS-REFERENCE TO RELATED APPLICATIONS

This application claims benefit of Provisional Application 62/615,567, filed Jan. 10, 2018, the entire contents of which are hereby incorporated by reference as if fully set forth herein, under 35 U.S.C. § 119(e).

### FIELD OF INVENTION

Highly available and high-quality packet based communications

### GOVERNMENT SUPPORT STATEMENT

This invention was made without government support.

### BACKGROUND INFORMATION AND PRIOR ART

Networks of general purpose computer systems connected by external communication links are well known and widely used in commerce. The networks often include one or more network devices that facilitate the passage of information between the computer systems. A network node is a network device or computer system connected by the communication links. An end node is a node that is configured to originate or terminate communications over the network. An intermediate network node facilitates the passage of data between end nodes.

Communications between nodes are typically effected by exchanging discrete packets of data. Information is exchanged within data packets according to one or more of many well-known, new or still developing protocols. In this context, a protocol consists of a set of rules defining how the nodes interact with each other based on information sent over the communication links. Each packet typically comprises 1] header information associated with a particular protocol, and 2] payload information that follows the header information and contains information that may be processed independently of that particular protocol. In some protocols, the packet includes 3] trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different layer of detail for information exchange. The header for a particular protocol typically indicates a type for the next protocol contained in its payload. The higher layer protocol is said to be encapsulated in the lower layer protocol.

The headers included in a packet traversing multiple heterogeneous networks, such as the INTERNET, typically include a physical (layer 1) header, a data-link (layer 2) header, an internetwork (layer 3) header and a transport (layer 4) header, as defined by the Open Systems Interconnection (OSI) Reference Model. The OSI Reference Model is generally described in more detail in Section 1.1 of the reference book entitled Interconnections Second Edition, by Radia Perlman, published September 1999, which is hereby incorporated by reference as though fully set forth herein.

The internetwork header provides information defining the source and destination address within the network. Notably, the path may span multiple physical links. The internetwork header may be formatted according to the Internet Protocol (IP), which specifies IP addresses of both a source and destination node at the end points of the logical path. Thus, the packet may “hop” from node to node along its logical path until it reaches the end node assigned to the destination IP address stored in the packet's internetwork header.

Some network layer addresses, including IP addresses, are hierarchical and can be aggregated. Hierarchical addresses are organized into numerous groups and subgroups and subgroups of subgroups, etc. Each layer of subgroups successively narrow the address space until at, the finest level of granularity of the address space, a single element of the network is indicated (e.g., a network interface card on a network node). A group address aggregates the addresses in the subgroups of that group.

Routers and switches are network devices that determine which communication link or links to employ to support the progress of data packets through the network. A network node that determines which links to employ based on information in the internetwork header (layer 3) is called a router. Some protocols pass protocol-related information among two or more network nodes in special control packets that are communicated separately and which include a payload of information used by the protocol itself rather than a payload of data to be communicated for another application. These control packets and the processes at network nodes that utilize the control packets are said to be in another dimension, a “control plane,” distinct from the “data plane” dimension that includes the data packets with payloads for other applications at the end nodes.

A link-state protocol is an example of a routing protocol, which only exchanges control plane messages used for routing data packets sent in a different routed protocol (e.g., IP). In a link-state protocol, two routers establish an adjacency relationship between them by first verifying direct two-way communication between them over the same network segment and then synchronizing their link-state databases. Link-state data describe all links to a router and describes the network addresses reachable on each of those links, as well as other properties of the link. Once the adjacency relationship is established, the two routers are called peers. During a reliable flooding stage of a link-state protocol, each router is required to ensure that each of its peers has received the link-state data describing the router's own links.

When establishing secure links between source and destination nodes, at least some payloads of data packets are often encrypted. The decryption information must be provided to the destination node, such as with public and private keys or other information communicated out of channel, that is, in a different communication channel than the channel carrying the data packets.

Packet based communications sometimes suffer from adverse packet loss, jitter, and latency. Various network and network access problems can jeopardize service availability. Certain government regulatory stances relative to Net Neutrality may undermine quality and availability.

The IETF standard RFC 4588 “RTP Retransmission Payload Format” specifies RTP re-transmission triggered by the monitoring the quality metrics in RTCP reports. The paper “iPRP: Parallel Redundancy Protocol for IP Networks” by Miroslav Popovic, Maaz Mohiuddin, Dan-Cristian Tomozei and Jean-Yves Le Boudec from École Polytechnique Federale de Lausanne (EPFL; English: Swiss Federal Institute of Technology in Lausanne); the draft RFC “iPRP: Parallel Redundancy Protocol for IP Networks”, draft-popovic-iprp-00, 10 Aug. 2015, Miroslav Popovic, Maaz Mohiuddin, Yean-=Yves Le Boudec, Dan-Cristian Tomozei from École Polytechnique Federale de Lausanne and Cisco Systems; the IETF standard RFC 7198 “Duplicating RTP Streams”; and U.S. Pat. No. 8,184,628 specify either Internet Protocol (IP) packet or Real-time Transport Protocol (RTP) replication over two sending paths merged and deduplicated at the destination as a means for compensating for packet loss with the added benefit of possibly reducing latency. The reduced packet loss benefit occurs if a packet loss on one path is present on the other path and the reduced latency benefit occurs when latency varies between any two duplicated packets as the first packet received is forwarded onwards. The IETF standard RFC 7656 “A Taxonomy of Semantics and Mechanisms for Real-Time Transport Protocol (RTP) Sources” states that one form of Forward Error Correction packets could be in the form of duplicated RTP packets. The IETF standard RFC 7197 “Duplication Delay Attribute in the Session Description Protocol” specifies the duplication of original packets that are then sent separated in time by at least T time units as a form of “time-shifted redundancy” also known as “temporal redundancy” and “delayed duplication”.

Collectively U.S. Pat. Nos. 8,743,683, 9,143,455, 9,717,021 and patent applications US 2016/0218947 and US2016/0255542 describe a virtual network overlay of multiple WAN paths potentially spanning multiple network providers and multiple networking technologies to connect sender and receivers of a communication. The monitoring of the quality of service of the virtual network overlay's traffic can be used as a criterium for selecting the optimal path for a given communication. Two or more multiple diverse WAN paths can be bonded together as a bonded virtual tunnel providing both increased capacity and resiliency. Error correction packets can be sent in parallel to the communication flows to help compensate for network transmission errors. IETF standard RFC 6015 “RTP Payload Format for 1-D Interleaved Parity Forward Error Correction (FEC)” also specifies the use of error correction packets sent in parallel to the communication flows with the intention of repairing corrupted packets.

### SUMMARY OF THE INVENTION

Techniques are described for improving the transport quality and transport availability of information to a destination node. Unlike the prior art involving replication over different WAN access links, these techniques, in various embodiments, dynamically select optimal replication paths under the command of an optimization controller.

The invention supports all packet based services including but not necessarily limited to real-time interactive full duplex voice and video, broadcast audio and video, streaming audio and video, machine to machine communications, Internet of Things communications, telemetry, and data communications.

The invention's control system creates high quality of service bonded paths each spanning two or more diverse communications circuits potentially spanning two or more providers and potentially spanning two or more wired and/or wireless transmission technologies composing a virtual overlay network by replicating packets at the sending side for transport over these bonded paths and merging and deduplicating at the receiving side.

The invention improves quality and availability by way of a virtual overlay of one or more Wide Area Networks (WANs), Local Area Networks (LANs), Wireless LANs (WLANs, e.g. IEEE 802.11 aka WiFi), Wireless WANs (WWANs, e.g. 3GPP LTE), Metropolitan Area Networks (MANs, e.g. IEEE 802.16 WiMAX), Mobile Ad Hoc Networks (MANETs), Satellite Networks, Radio Access Networks (RANs), or any other type of network, or hybrid network (e.g. wired and wireless), or combination thereof. Though invented with the intent of benefiting real-time services the invention also benefits simplex as well as near real-time and non-real-time (aka data) services.

Packet replication over diverse paths compensates for packet loss and will also oftentimes reduce end to end latency by playing the first received replicant packet. The instances of replication convey over bonded paths such as bonded IP tunnels. The replication also provides for uninterrupted service should a path within the bonded path set be severed or somehow interrupted. The replication may be duplication, triplication, or some n number of replications or some fractional additional replication.

If “m” is the number of paths within a set of bonded diverse replication paths and if “n” is the number of replicants then n may equal m or n may be greater than m or n may be less than m. Also note that the number of replicants “n” might be some fraction greater than 1. For n=2.5 there would be two full replicants and one half replicant.

Quality monitoring of synthetic traffic across all possible paths or the combination of synthetic traffic along unused paths and actual traffic provides input to the control system for dynamically and autonomously managing the bonded diverse replication paths on a per bonded diverse replication paths set basis. Monitored for quality the synthetic streams may span the full mesh of access links across all possible sender and receiver locations. The dynamic analysis of the real-time quality information enables the control system to dynamically optimize the paths that comprise a given set of bonded paths. Cost aspects (e.g. metered usage) may also be considered.

For a given path within a given set of bonded diverse replication paths, a path may be one way or bi-directional.

The number of actively employed links on one side of a given set of bonded diverse replication paths may be different than the number of actively employed links on the other side of this set of bonded paths. The number of replicants may also vary by direction.

Over the course of the life of a given communication's transaction if transaction based or session if session based the employed bonded diverse replication paths set may change in response to virtual overlay network wide Quality of Service (QoS) and path availability monitoring.

Since packet replication consumes bandwidth the control system is able to minimally replicate a portion of a communication's packets to meet a quality of service threshold. The decision to replicate and the extent of the replication can also be a function of the application (e.g. Voice session, voice and video session, email message).

Between two locations the control system may create distinct sets of bonded diverse replication paths designating different traffic to be replicated at different replication rates over each set.

The end to end path in any one direction may span two or more contiguous sets of bonded paths thus the replication, merge, and deduplication of packets may take place at multiple points along the end to end path of a packet based communication thereby improving the minimization of packet loss.

### BRIEF DESCRIPTION OF DRAWINGS

Embodiments are illustrated by way of example, and not by way of limitation, in the figures of the accompanying drawings in which like reference numerals refer to similar elements and in which:

FIG. 1 is a block diagram that illustrates a packet tunnel in one direction where an encapsulating packet contains in its payload the original packet.

FIG. 2 is a block diagram that illustrates an example of two unidirectional bonded packet tunnels conveying replicated packets generated by a sending Replication Sender and Merge and Deduplication Receiver (RSMDR) and a receiving RSMDR.

FIG. 3 is a block diagram that illustrates the packet encapsulation of an original packet along with the tunnel header values required for the replication on the sending side and the merge and deduplication on the receiving side.

FIG. 4 is a block diagram that illustrates a RSMDR with two sets of bonded paths with each set connecting on the other side to a different RSMDR.

FIG. 5 is a block diagram that illustrates in one direction the packet replication through a bonded paths mitigating both packet loss and latency.

FIG. 6 is a block diagram that illustrates zero downtime demonstration in one direction for when one path within a pair of bonded paths severs.

FIG. 7 is a block diagram that illustrates duplicated packets sent in one direction over a set of two bonded paths and in another illustration triplicated packets sent in one direction over a set of three bonded paths and the benefits thereof.

FIG. 8 is a block diagram illustration in one direction of duplicated packets, that is two replicants of packets, where the two replicants convey evenly across three bonded paths.

FIG. 9 is a block diagram that illustrates the taking of quality assessments of all possible paths that may be used as the basis for optimally establishing one or more sets of bonded paths.

FIG. 10 is a block diagram that illustrates the taking of quality assessments of the existing set of two bonded diverse replication paths as well as all possible paths that could be used as alternative paths for comprising the set of bonded diverse replication paths, the intelligence that processes this information labeled here as the Bonded Paths Optimization Intelligence, and this intelligence's subsequent instructions dynamically managing the construction of one set of bonded paths and the associated replication.

FIG. 11 is a block diagram that illustrates how a pair of RSMDRs under the control of the Bonded Paths Optimization Intelligence may exchange replicated packets over one path.

FIG. 12 is a block diagram that illustrates how a RSM DR may send replicated packets to another RSMDR, both under the control of the Bonded Paths Optimization Intelligence, via a single WAN Access Link.

FIG. 13 is a block diagram that illustrates how under the control of the Bonded Paths Optimization Intelligence a RSMDR may duplicate packets sent over two access links to two access links at the destination RSM DR and vice versa.

FIG. 14 is a block diagram that illustrates per the control of the Bonded Paths Optimization Intelligence a set of bonded diverse replication paths composed of both bi-directional and unidirectional paths.

FIG. 15 is a block diagram that illustrates how the set of Bonded Diverse Replication Paths between two RSMDRs may per the instructions from the Bonded Paths Optimization Intelligence vary by direction.

FIG. 16 is a block diagram that illustrates how replicated traffic controlled by the Bonded Paths Optimization Intelligence may involve three RSMDRs such that one RSMDR sits between the other two RSM DRs.

FIG. 17 is a block diagram that depicts edge RSMDRs at local and regional networks such as LANs, WLANs, MANs, and Clouds and also the RSMDR function embedded within endpoints both of which attach to a virtual network overlay composed of a number of networked RSMDRs where network RSMDRs may be used not only to replicate, merge, and deduplicate packets but also serve as steering points to route traffic around congestion.

FIG. 18 is a block diagram that illustrates partial replication to improve quality to meet a certain threshold thereby limiting the resources necessary to support packet replication relative to full blown replication.

FIG. 19 is a block diagram that illustrates a pair of RSMDRs under the control of the Bonded Paths Optimization Intelligence sharing two sets of bonded diverse replication paths where for instance one set of bonded paths might be used exclusively for full duplex interactive Voice and Video over IP (VVoIP) services whereas the second set of bonded paths might be used exclusively for one way VVoIP streaming services.

FIG. 20 is a block diagram that illustrates two overlapping sets of bonded diverse replication paths.

FIG. 21 is a block diagram that illustrates one possible embodiment of how the Bonded Paths Optimization Intelligence function instructs a RSMDR to construct one or more sending sets of bonded diverse replication paths implemented as IP tunnels and how to use these bonded path sets.

FIG. 22 is a block diagram that illustrates at a very high level the finite state machine spanning the Bonded Paths Optimization Intelligence (BPOI) function and a pair of elements with the RSMDR functions that exchange traffic with each other over one or more sets of bonded replication paths.

FIG. 23 is a block diagram that illustrates a computer system upon which an embodiment of the invention may be implemented;

FIG. 24 illustrates a chip set upon which an embodiment of the invention may be implemented; and

FIG. 25 is a diagram of exemplary components of a mobile terminal (e.g., cell phone handset) for communications according to one embodiment.

### DETAILED DESCRIPTION OF THE INVENTION

### 1. Overview and Method

Techniques are described for improving the transport quality and transport availability of information to a destination node. These techniques, in various embodiments, dynamically select optimal replication paths under the command of an optimization controller. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Some embodiments of the invention are described below in the context of packet IP networks and within them IP tunnels. However, the invention is not limited to this context. In other embodiments the invention applies to any and all types of communications networks (e.g. IP, MPLS, ATM, circuit switched, Frame Relay, X.25). Within network types other than IP, IP tunnel equivalents or similar constructs would be employed. For instance in a MPLS network a MPLS label-switched path may be used in lieu of an IP tunnel.

The invention supports all packet based services including but not necessarily limited to real-time interactive full duplex voice and video, broadcast audio and video, streaming audio and video, machine to machine communications, Internet of Things communications, telemetry, and data communications.

Most aspects of the invention are explained using Internet Protocol (IP) based networks but the invention may operate in any network type including those unassociated with IP.

The invention replicates packets over dynamically bonded paths, potentially spanning two or more networks potentially spanning two or more different network types and thus establishing a virtual network overlay, that minimizes packet loss and latency while also providing high availability. Near or at the destination the invention then merges and deduplicates the received replicated packets. The decision to replicate and the extent of the replication can apply to all communications or be a function of the type of communications (e.g. Voice session, voice and video session, telemetry, etc.).

Each set of bonded diverse replication paths span two or more bi-directional or unidirectional paths, potentially spanning one or more providers and potentially spanning one or more wired and/or wireless transmission technologies. The virtual network overlay may span one or more Wide Area Networks (WANs), Local Area Networks (LANs), Wireless LANs (WLANs), Wireless WANs (WWANs), Metropolitan Area Networks (MANs), Mobile Ad Hoc Networks (MANETs), Satellite Networks, Radio Access Networks (RANs) any other type of network, or hybrid network (e.g. wired and wireless).

The invention's intelligence uses the quality of service monitoring of synthetic traffic or both synthetic and actual traffic to initially select and to then reselect on a continuous basis the optimal diverse paths amongst the set of possible paths for constructing the dynamically bonded paths transporting the replicated packets.

A Replication Sender and Merge and Deduplication Receiver (RSMDR) sits at each end of the bonded paths.

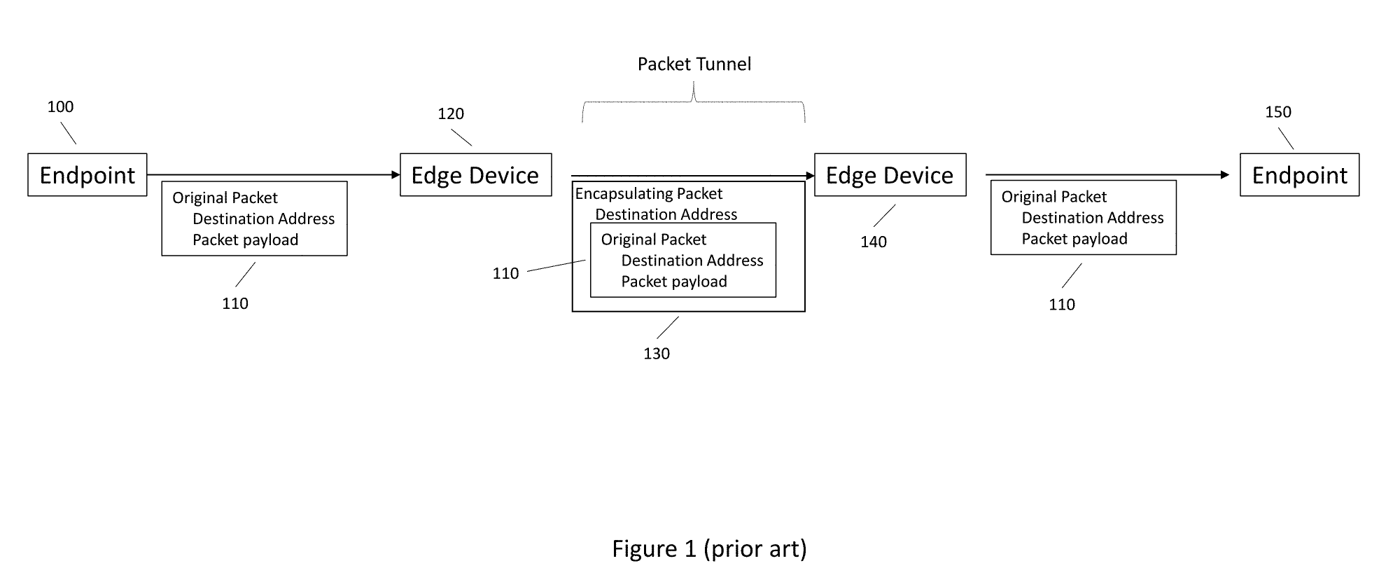

FIG. 1 (prior art) illustrates packet tunneling in one direction (also one direction for a bi-directional tunnel). In the context of the Internet Protocol (IP) it would be called an IP tunnel. Endpoint 100 sends Original Packet 110 to Edge Device 120. Edge Device 120 encapsulates the Original Packet 100 from Endpoint 100 into an Encapsulation Packet 130. The destination of this encapsulating packet is Edge Device 140. When Edge Device 140 receives the encapsulating packet, it extracts the Original Packet 110 from the encapsulating packet's payload and forwards it on towards the intended destination Endpoint 150 destination. In the an IP based embodiment the RSMDRs also perform packet tunneling.

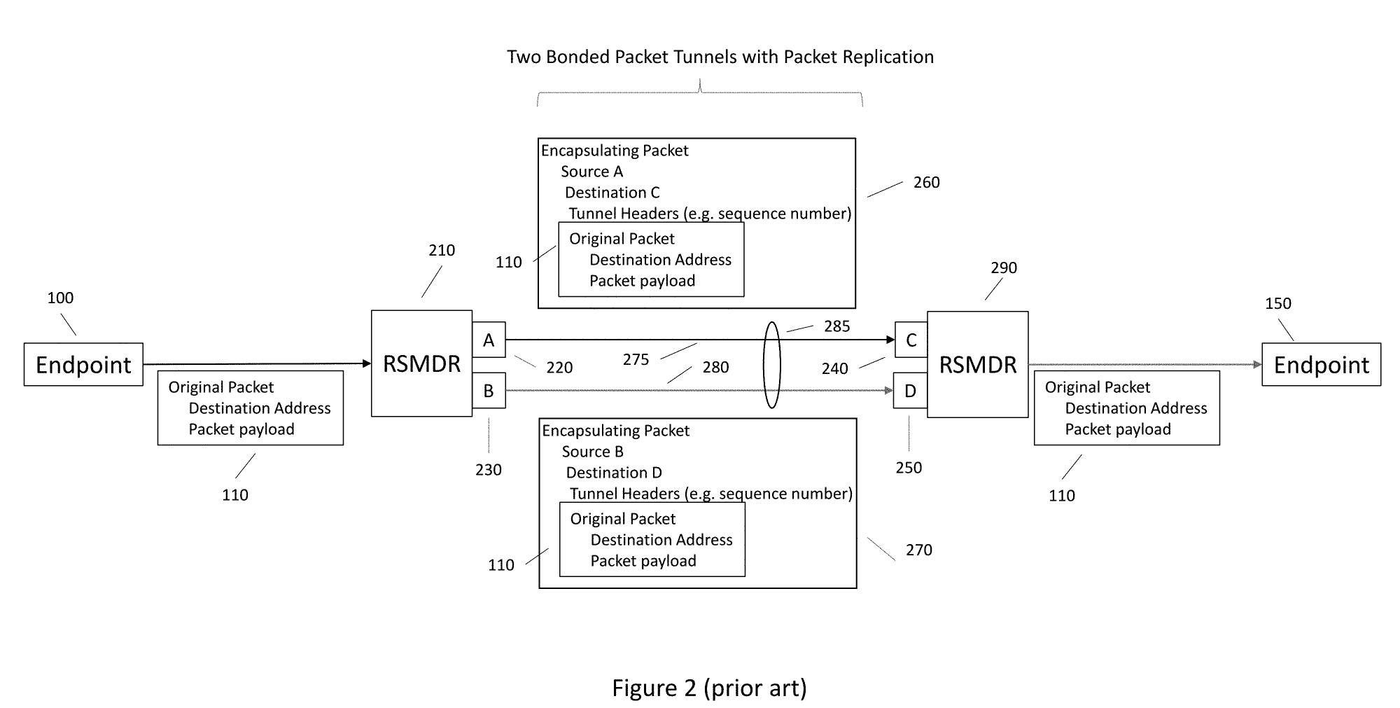

In FIG. 2 illustrating prior art in one direction from Endpoint 100 to Endpoint 150 an example of two IP tunnels 275 and 280 bonded together as 285, thus known as “bonded tunnels”, convey replicated packets from RSMDR 210 towards RSMDR 290. On a configurable traffic type basis (e.g. IPv4 Protocol Header indicating UDP) the sending RSMDR 210 replicates each Original Packet 110 from the sending Endpoint 100 and sends one replicated instance inside encapsulating packet 260 over packet tunnel 275 involving WAN Access Link A 220 and WAN Access Link C 240 and the other replicated instance 110 inside encapsulating packet 270 over the packet tunnel 280 involving WAN Access Link B 230 to WAN Access Link D 250 towards the destination RSMDR 290. The destination RSMDR 290 extracts the received encapsulated packets 110 from the encapsulating packets 260 and 270 received over the bonded tunnels 285 comprised of the tunnels 275 and 280, properly orders these packets 110, and drops one of the two replicated instances (also known as deduplicating) before forwarding the packet 110 on towards the destination Endpoint 150. Each RSM DR 210 and 290 may support many Endpoints (e.g. 100 and 150). The replicated traffic of the many endpoints multiplexes through the common tunnels 275 and 280 composing the set of bonded tunnels 285 between the two RSMDRs 210 and 290. Note that any traffic not selected for replication may still employ the set of bonded tunnels without undergoing replication or may simply be conveyed externally relative to the set of bonded tunnels 285. The fact that both tunnels 275 and 280 carry the same replicated traffic is what makes these two tunnels be “bonded”.

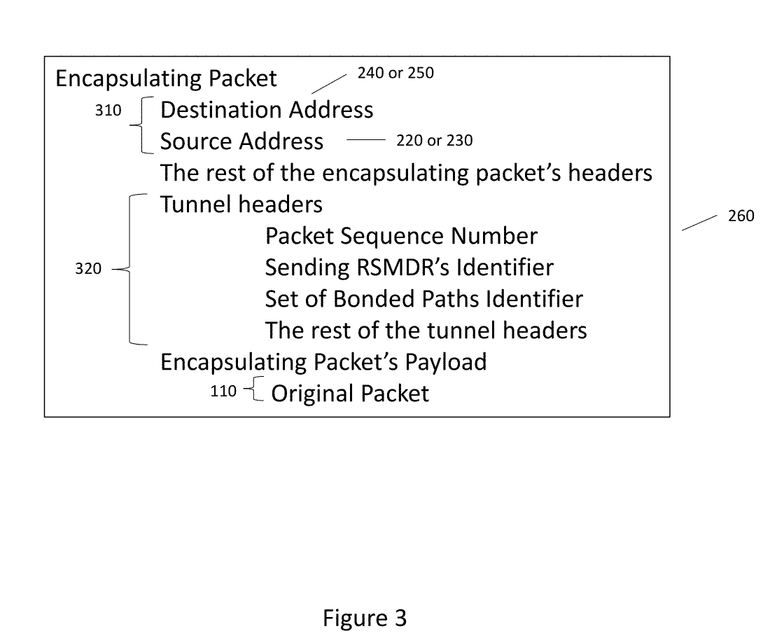

In an embodiment illustrated by FIG. 3 an encapsulated packet 260 forms the basis for a packet tunnel (e.g. 275 or 280 in FIG. 2) intended to support the conveyance of replicated instances of traffic. An original packet 110 fits into the payload of the encapsulating packet 260. The encapsulating packet's source address within 310 specifies which WAN Access Link to use (220 or 230 in FIG. 2) for sending RSM DR 210 and the destination address within 310 is to an address of the destination RSM DR 290 via one of its WAN Access Links (240 or 250 in FIG. 2). Through replication the original packet sits in encapsulating packets of two or more other bonded tunnels comprising the set of bonded tunnels (e.g. 285 in FIG. 2). The receiving RSMDR (e.g. 290 in FIG. 2) identifies the bonded tunnel by value of the Set of Bonded Paths Identifier header within 320. All bonded tunnels (e.g. 275 and 280 in FIG. 2) within the Set of Bonded Paths Identifier instance share the same Packet Sequence Number values. In other words, a given instance of replicants of a given original packet 110 within the encapsulating packets 260 with a common a Set of Bonded Paths Identifier within 320 share the exact same Packet Sequence Number value within 320. The destination RSMDR (e.g. RSMDR 290 in FIG. 2) on a per Set of Bonded Paths Identifier basis merges together the received encapsulated packets 260 and orders them in proper sequence per the Packet Sequence Number within 320 within each encapsulating packet 260. Such encapsulating packets 260 with duplicated Packet Sequence Numbers are dropped. Then the payload, the original packet 110, is extracted and forwarded onwards towards its intended destination (e.g. Endpoint 150 in FIG. 2). Note that the Sending RSM DR's Identifier within 320 also enables any one RSMDR to establish a set of bonded paths with two or more other RSMDRs without the Set of Bonded Paths Identifier having to be unique across all RSMDRs.

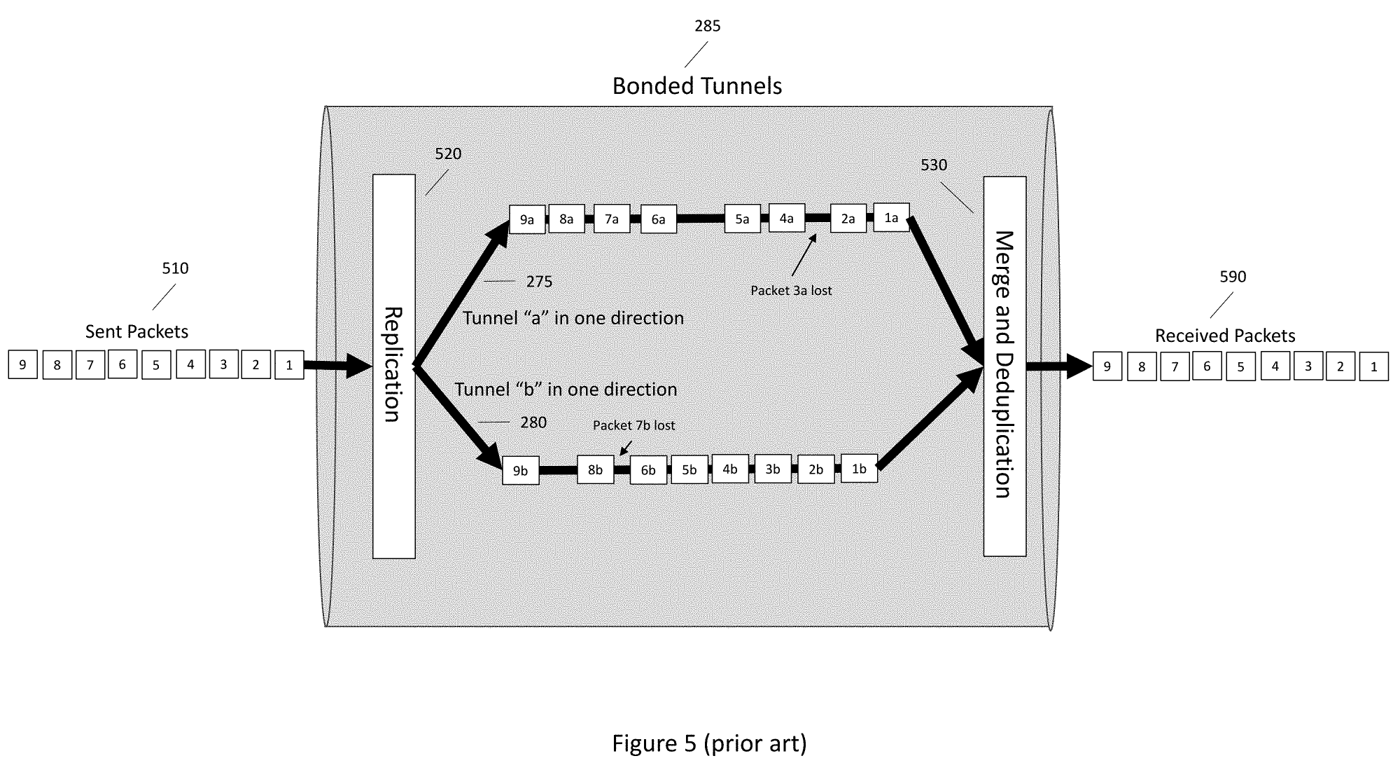

Packet replication compensates for packet loss. It may also reduce end to end latency if the first packet instance of the received replicated packets varies between paths on a replicated packet by replicated packet basis. FIG. 5 illustrates the prior art where sent packets 510 are replicated by function 520 to send one replicant along tunneled path “a” 275 and another replicant tunneled along path “b” 280. Note that the replicated packets are labeled either “a” and “b”. FIG. 5 illustrates the handling of 9 sent packets 510. Along the tunnel 275 conveying the “a” replicant of packets, packet 3a is lost. Along the tunnel 280 conveying the “b” replicant of packets, packet 7b is lost. Note that each tunnel has a copy of the packet that the other tunnel lacks, hence, packet loss was prevented. The illustration also shows some varying latency amongst the replicated packets across the two tunnels and thus latency is reduced by playing the first received copy of each packet.

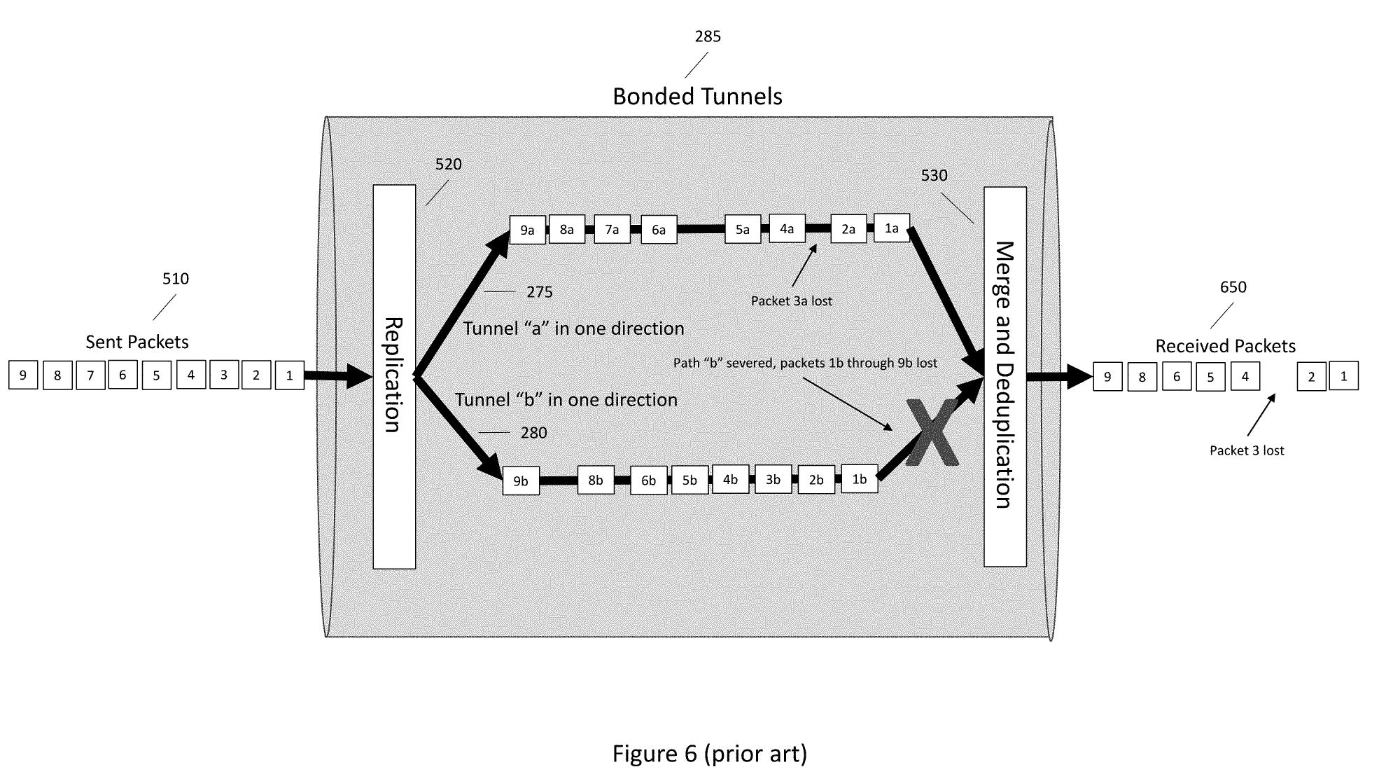

Note that replication also provides for uninterrupted service should one of the tunnels within the set of bonded paths be severed or somehow interrupted as illustrated in the prior art FIG. 6. As illustrated tunnel “b” 280 severs somewhere along its path. The replicated packets 1b through 9b are lost; however, packets 1a through 9a along tunnel “a” 275 are delivered at the destination per 590. The replication benefit of compensating for lost packets is lost (i.e. packet 3 is lost per 590) but the communication survives.

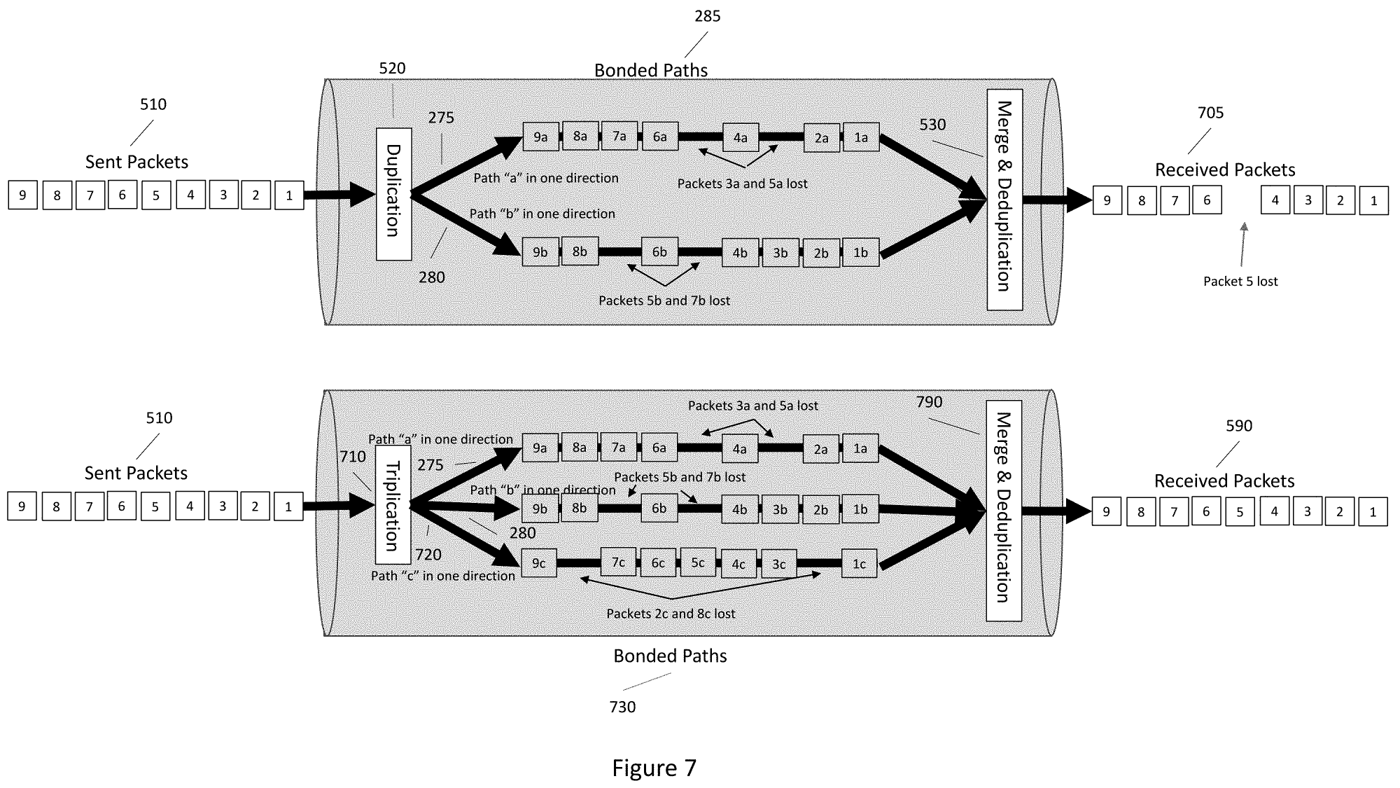

The replication option may not be just duplication across two paths but also triplication across three paths, or some n number of replications across m paths where n may equal to m or n may be greater than m or n may be less than m. In an embodiment illustrated by FIG. 7 both duplication and triplication are depicted. The duplication replicants are labeled as “a” and “b”. The triplication replicants are labeled “a”, “b”, and “c”. The illustration depicts the handling of nine sent packets 510. In the duplication depiction the “a” replicants convey over paths 275 and 280. For each replicated instance pair of the sent packets 510, they share the same Packet Sequence Number, Sending RSMDR's Identifier and Set of Bonded Paths Identifier per FIG. 3. Along path 275 packets 3a and 5a are lost. Along path 280 packets 5b and 7b are lost. The Merge & Deduplication function 530 compensates for the loss of packets 3a and 7b but not the loss of both 5a and 5b as shown by post merge and deduplicated Received Packets 705. In the Triplication 710 “a” replicants as before convey over path 275 and “b” replicants convey over 280 but now “c” replicants also convey over path 720. As before packets 3a and 5a are lost along path 275, packets 5b and 7b are lost along path 280, and packets 2c and 8c are lost along path 720. The Merge and Deduplication function 790 is able to compensate for all missing packets across the three paths and thus the post merge and deduplicated Received Packets 590 suffers from no packet loss.

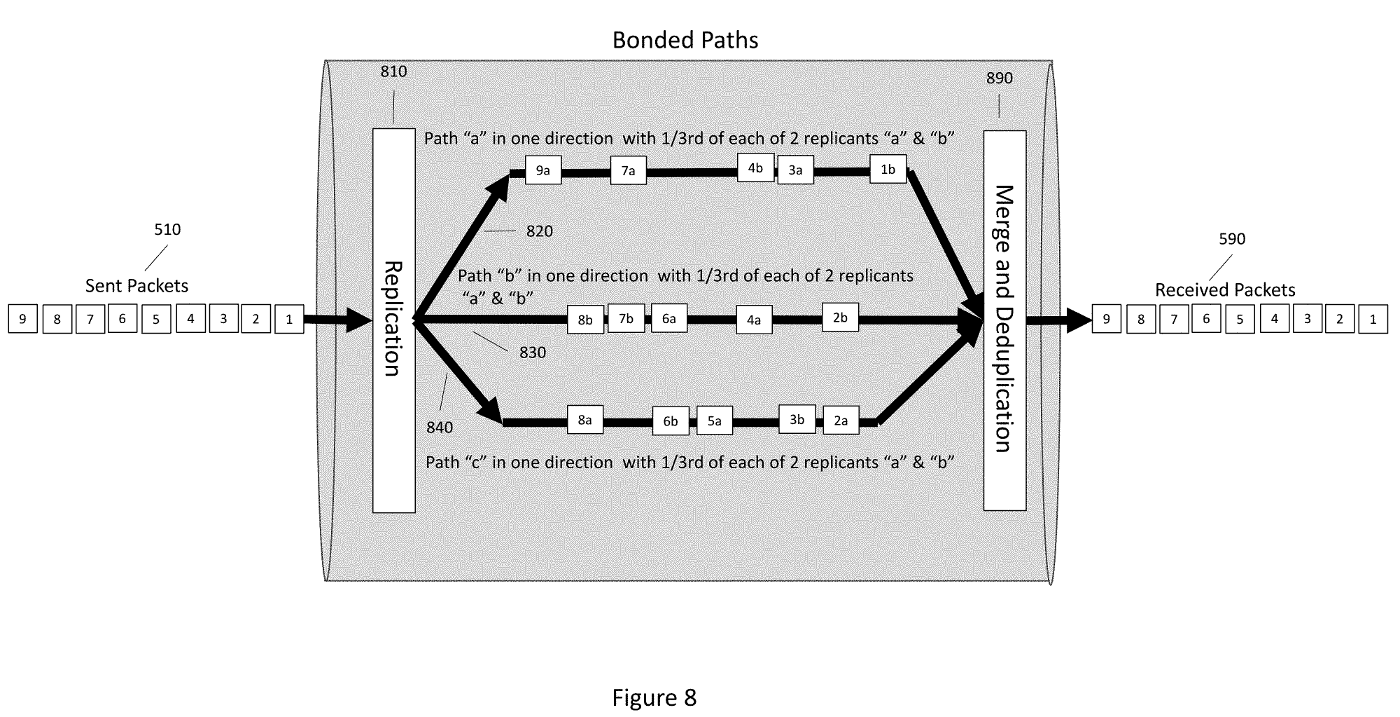

As previously stated there may be n replications across m paths where n may equal to m or n may be greater than m or n may be less than m. In other words within the set of bonded paths the number of replicants may be the same as the number of paths or the number of replicants may vary with respect to the number of paths. When the number of replicants n is less than or equal to the number of paths m, duplicates of a given packet from within 510 should not take the same path. In an embodiment illustrated by FIG. 8 two replicants convey over three paths. The Replication function 810 duplicates the packets 510 into replicants “a” and “b”. One third of each conveys over path “a” 820, one third over path “b” 830, and the remaining third over path “c” 840. The replicants are distributed across the three paths 820, 830 and 840 in such a way that the duplicated pair instances do not convey over the same path. For each pair of duplicated packets regardless of which path they take they share the same Packet Sequence Number, Sending RSMDR's Identifier, and Set of Bonded Paths Identifier from within 320 from FIG. 3 to enable the merge, deduplication, and proper ordering. In the illustration note that packets 1a, 5b, and 9b are missing but 1b, 5a, and 9a reach the destination and thus the Received Packets 590 post merge suffers no packet loss.

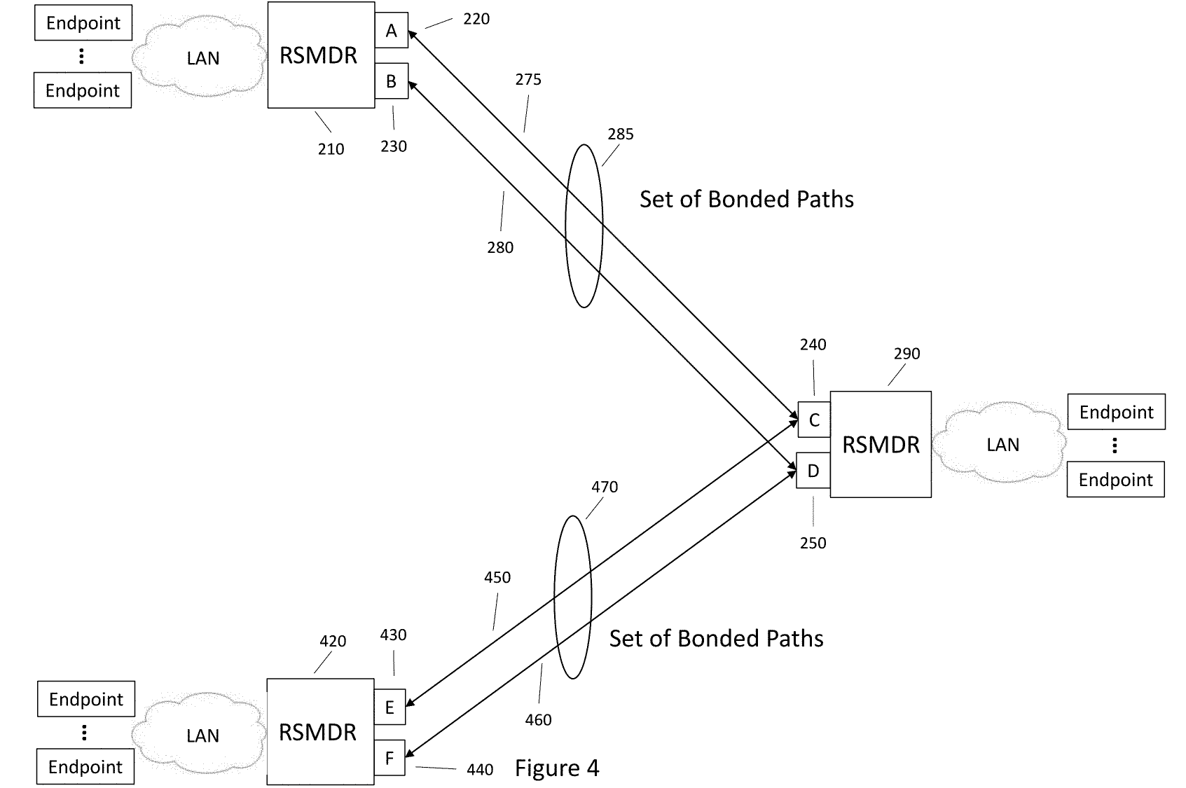

A RSM DR may establish bonded diverse replication paths with one or more other RSMDRs. In an embodiment illustrated by FIG. 4 one RSMDR 290 establishes one set of bonded diverse replication paths 285 with RSMDR 210 and a different set of bonded diverse replication paths 470 with RSMDR 420. The Set of Bonded Paths Identifier in combination with the Sending RSMDR's Identifier both within 320 of FIG. 3 enables a given RSM DR to jointly support two or more sets of bonded paths without ambiguity with one or more other RSMDRs.

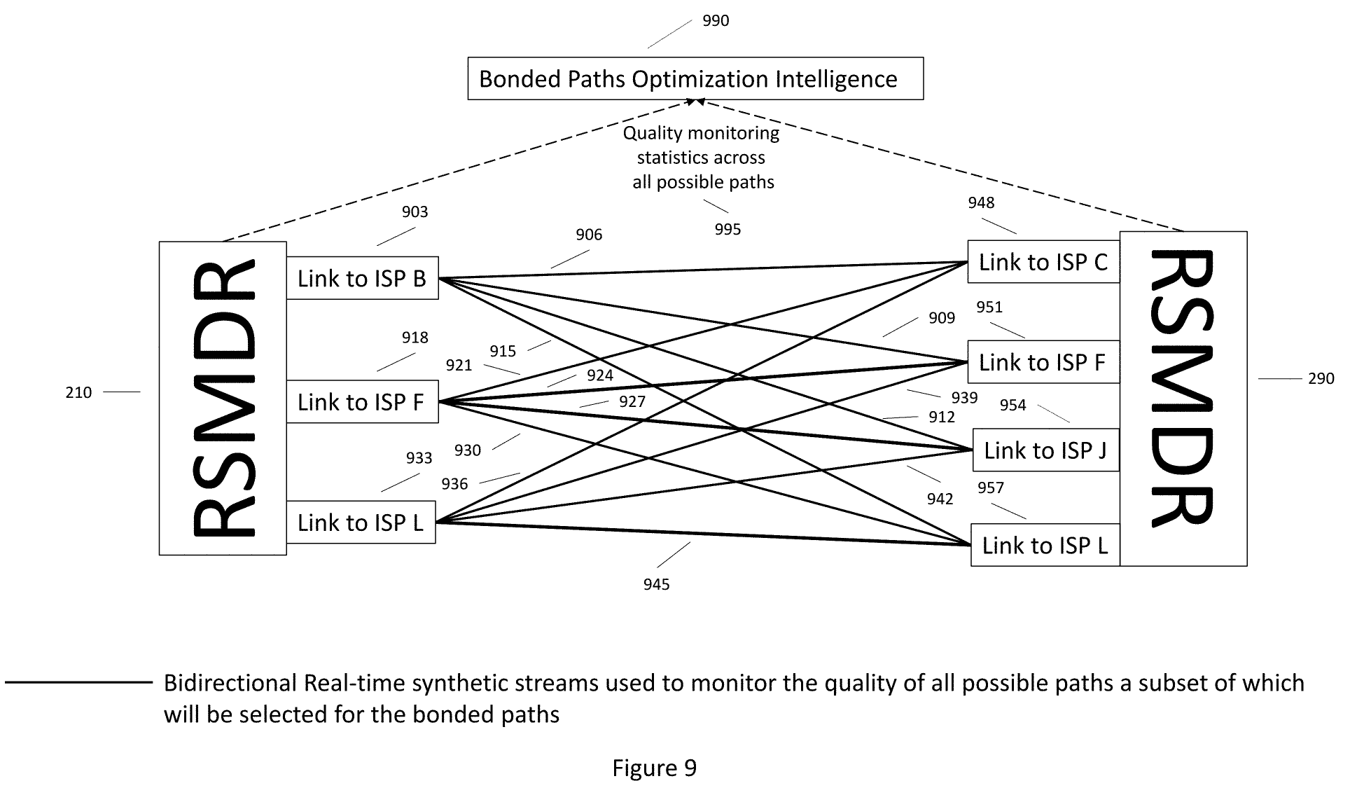

As a precursor to establishing bonded diverse replication paths between two RSMDRs, the two RSMDRs monitor the quality of generated synthetic streams they exchange with each other across all possible paths. Statistics such as packet loss rate, jitter, and latency are calculated. If IP/UDP/RTP streams are used as synthetic Voice over IP calls, then R Factor and/or Mean Opinion Score (MOS) may also be calculated. A Bonded Paths Optimization Intelligence function, previously named the “control function” in the Summary of the Invention section, analyzes all this quality monitoring information possibly in combination with other business factors such as metered path usage costs to determine the number of replicants (e.g. duplication, triplication) and the number of paths to bond between the two RSMDRs. Note that for reasons of scaling and high availability the Bonded Paths Optimization Intelligence may exist as two or more instances physically separated from the RSMDRs they control or alternatively may be highly distributed such that the instances are embedded with the RSMDRs. In an another embodiment some instances of Bonded Paths Optimization Intelligence may sit outside of some RSMDRs while other instances reside in the remaining RSMDRs. In yet another embodiment the Bonded Paths Optimization Intelligence function may be split with some of the functionality within the RSM DR and the rest of the functionality at centralized locations each supervising multiple RSMDRs. In an embodiment illustrated by FIG. 9, RSM DR 210 exchanges bidirectional synthetic traffic to be monitored for quality (e.g. packet loss rate, latency, jitter) with RSMDR 290 between Link to ISP B 903 to Link to ISPC C 948 via path 906, Link to ISP B 903 to Link to ISP F 951 via path 909, Link to ISP B 903 to Link to ISP J 954 via path 912, Link to ISP B 903 to Link to ISP L 957 via path 915, Link to ISP F 918 to Link to ISP C 948 via path 921, Link to ISP F 918 to Link to ISP F 951 via path 924, Link ISP F 918 to Link to ISP J 954 via path 927, Link ISP F 918 to Link to ISP L 957 via path 930, Link to ISP L 933 to Link to ISP C 948 via path 936, Link to ISP L 933 to Link to ISP F 951 via path 939, Link to ISP L 933 to Link to ISP J 954 via path 942, and Link to ISP L 933 to Link to ISP J 957 via path 945. The QoS monitoring of the paths at each RSM DR 995 are reported to the Bonded Paths Optimization Intelligence 990.

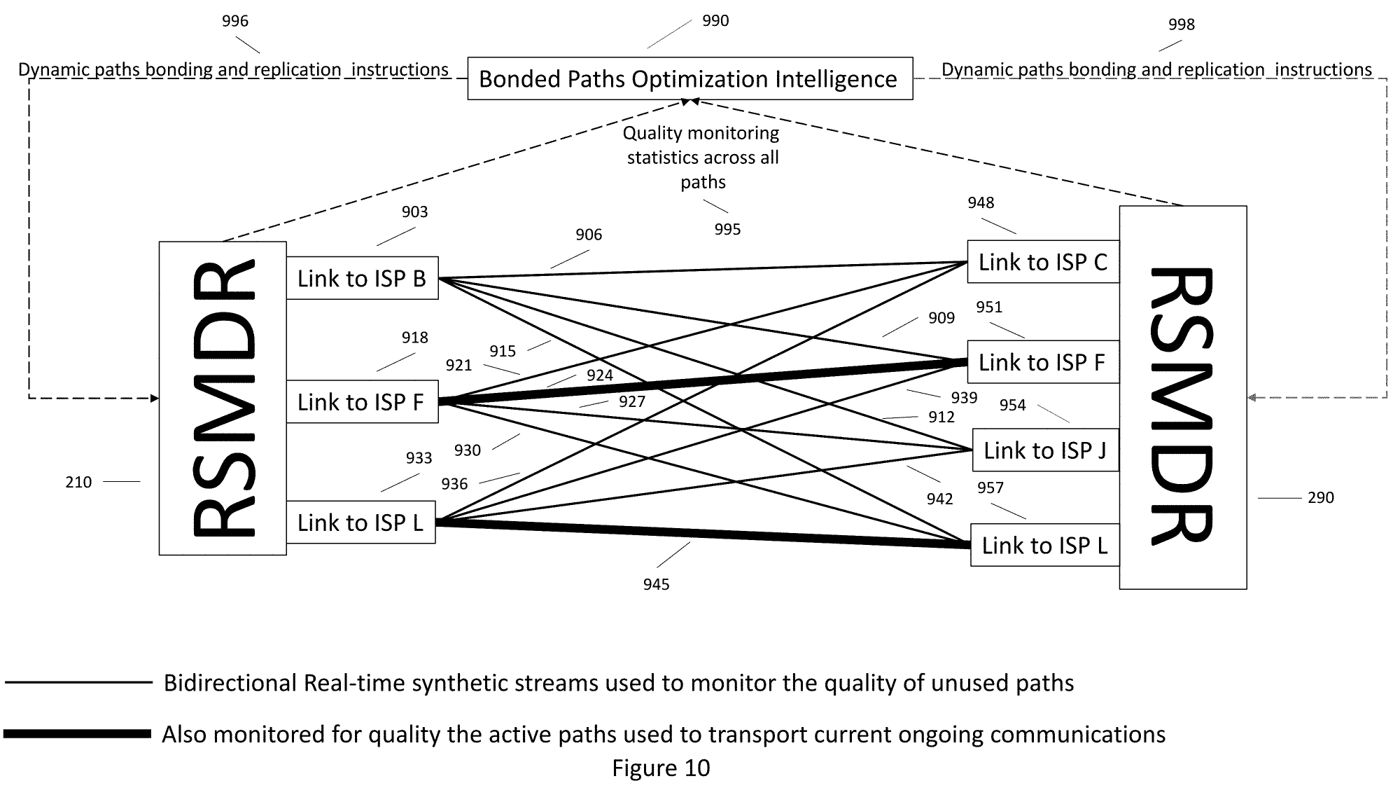

Bonded Paths Optimization Intelligence instructs RSM DR pairs to establish bonded diverse replication paths between each other in support of replication of all traffic or selected traffic. For instance, the replication instructions might be to replicate all the RTP traffic and to send a replicant through each bonded path. Note that some traffic may not be replicated. Some traffic may not even convey through the set of bonded paths and may instead convey outside the set of bonded paths. The synthetic streams are maintained for the unused paths. Then both the synthetic streams and the bonded paths will be continuously monitored for quality. Should these quality assessments significantly change over time or should a bonded path go down the Bonded Paths Optimization Intelligence will modify the set of bonded diverse replication paths to maintain optimal quality. A modification may add a bonded path, remove a bonded path, replace one bonded path with another bonded path, change a unidirectional path to bidirectional, change a bidirectional path to unidirectional, change the replication distribution across the bonded paths, change the number of replicants, or increase or decrease partial replication. In an embodiment illustrated by FIG. 10 which has transitioned from the start state of the embodiment in FIG. 9, bonded paths 924 between ISP links 918 and 951 and 945 between links 933 and 957 convey real replicated traffic per instructions from the Bonded Paths Optimization Intelligence 990 which in turns maintains the synthetic traffic on the remaining unused paths 906 connecting links 903 and 948, 909 connecting links 903 and 951, 912 connecting link 903 and 954, 915 connecting links 903 and 957, 921 connecting links 918 and 948, 927 connecting links 918 and 954, 930 connecting links 918 and 957, 936 connecting inks 933 and 948, 939 connecting links 933 and 951, and 942 connecting links 933 and 957. The QoS monitoring on the real-traffic and synthetic traffic 995 conveys back to Bonded Paths Optimization Intelligence 990 which may in turn trigger changes to the composition of the Bonded IP Paths per instructions 998 and 996.

Note that the severing of a bonded packet path may trigger the Bonded Paths Optimization Intelligence to recompose the Bonded IP Paths and/or the replication instructions to maintain the high level of overall service quality and availability.

In another embodiment, even after Bonded IP Paths are established to convey real traffic per FIG. 10 paths 924 and 945, synthetic traffic per these same paths per FIG. 9 could be assessed for quality rather than that of the actual live traffic. As a function of implementation, the synthetic streams may convey inside or outside of the bonded paths.

The optimal construction of the Bonded IP Paths between a given pair of RSMDRs may vary over time as a function of varying conditions. Examples of changing conditions include but are not necessarily limited to changes in one or more paths within a set of bonded diverse replication paths regarding the packet loss rate, latency, jitter, and metered usage cost rate.

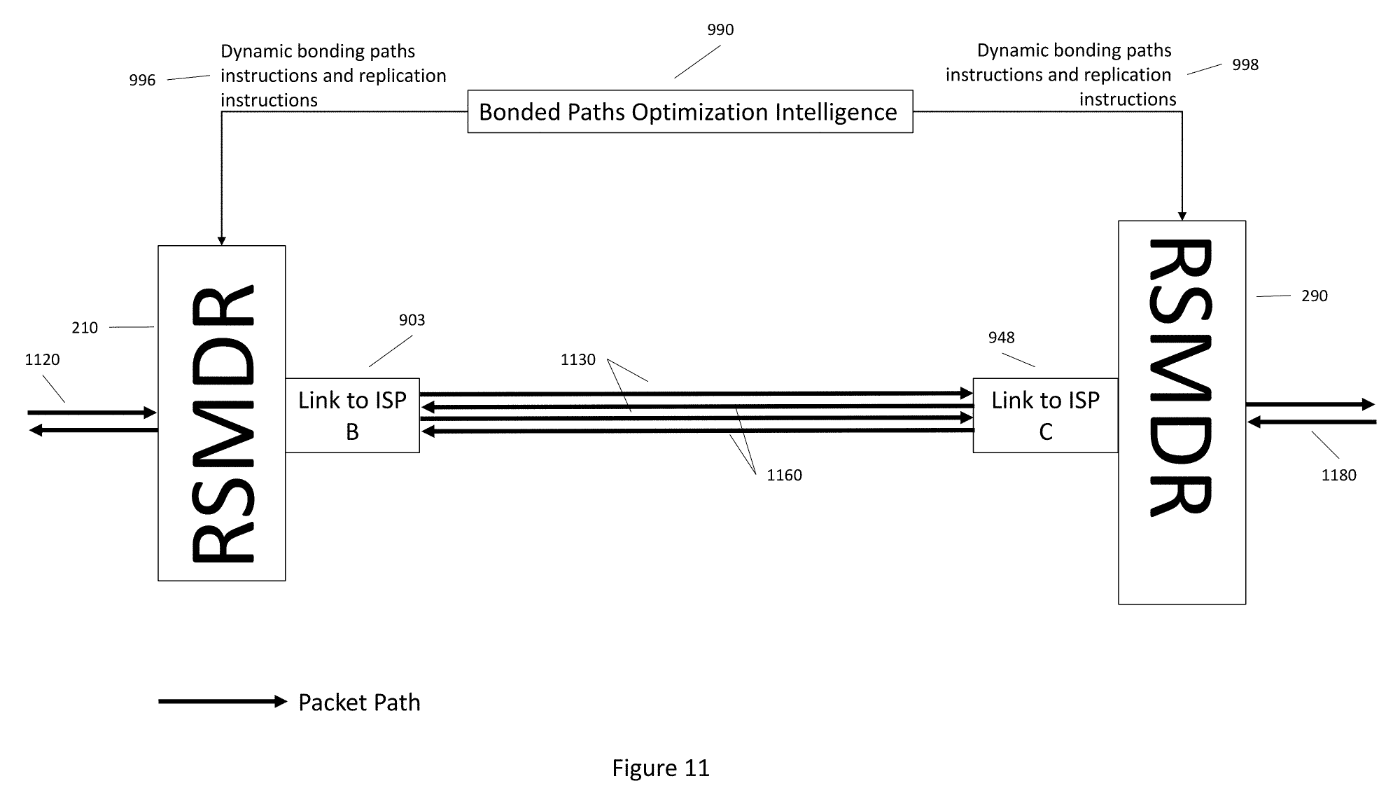

Per instructions from the Bonded Paths Optimization Intelligence the replication of traffic may take place along a single path. In an embodiment illustrated by FIG. 11, two RSMDR 210 and 290 each only have a single network access link, 903 at RSMDR 210 and 948 at RSMDR 290, and thus they have but a single path between them labeled as 1130 in one direction and 1160 in the other direction. Path and direction 1130 conveys two replicants of traffic 1120 and path and direction 1160 conveys two replicants of traffic 1180.

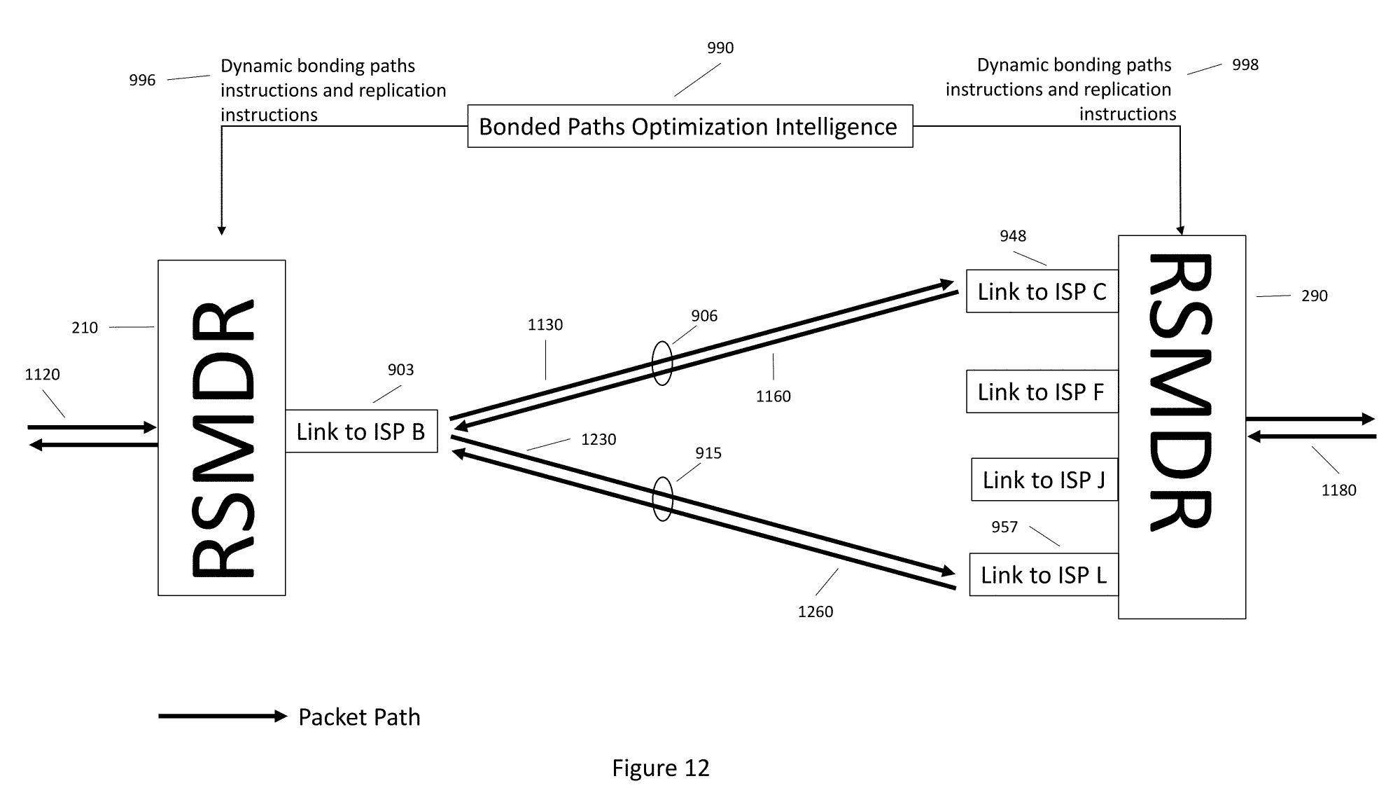

Within a RSM DR pair connected over bonded diverse replication paths, the number of WAN access links may vary relative to each RSMDR. In an embodiment illustrated by FIG. 12 RSMDR 210 employs one link 903 to establish two bi-directional paths IP paths 915 and 906 with RSMDR 290 by way of RSMDR 290's ISP links 948 and 1260. From RSMDR 210 to RSMDR 290 a replicant of 1120 conveys over path 906 in direction 1130 and another replicant of 1120 conveys over path 915 in direction 1230 whereas from RSMDR 290 to RSMDR 210 one replicant of 1180 conveys over the path 906 in direction 1160 and the other replicant of 1180 conveys over the path 915 in direction 1260.

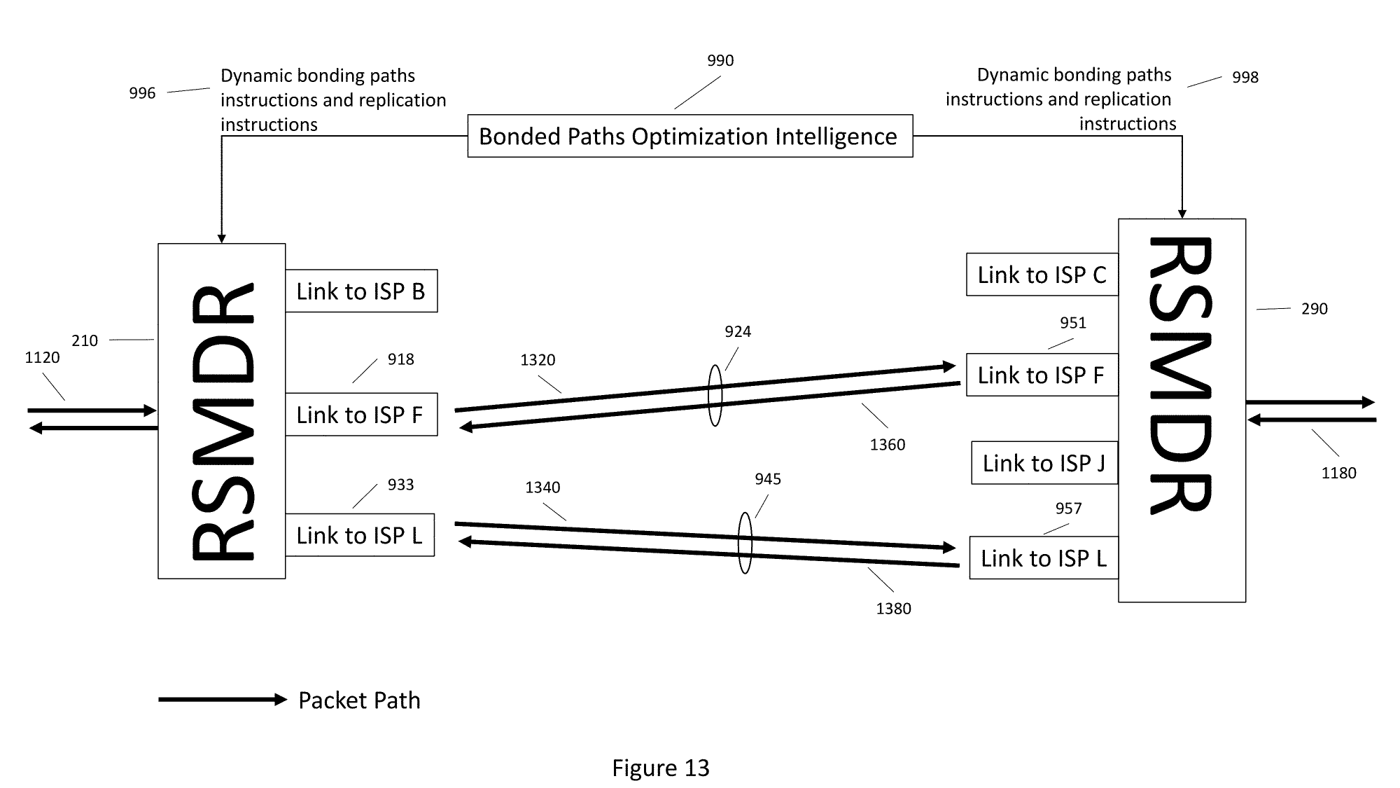

Per instructions from the Bonded Paths Optimization Intelligence, the replication paths within the bonded replication paths set may be diverse (not overlap). In an embodiment illustrated by FIG. 13 per the instructions of Bonded Paths Optimization Intelligence 990 traffic 1120 is replicated over RSM DR 210's links 918 and 993 through bi-directional paths 924 and 945 via path and direction 1320 and 1340 to links 951 and 957 of RSMDR 290. In the opposite direction traffic 1180 is replicated by RSM DR 290 and forwarded across its links 951 and 957 also over the bi-directional IP paths 924 and 945 over path and direction 1360 and 1380.

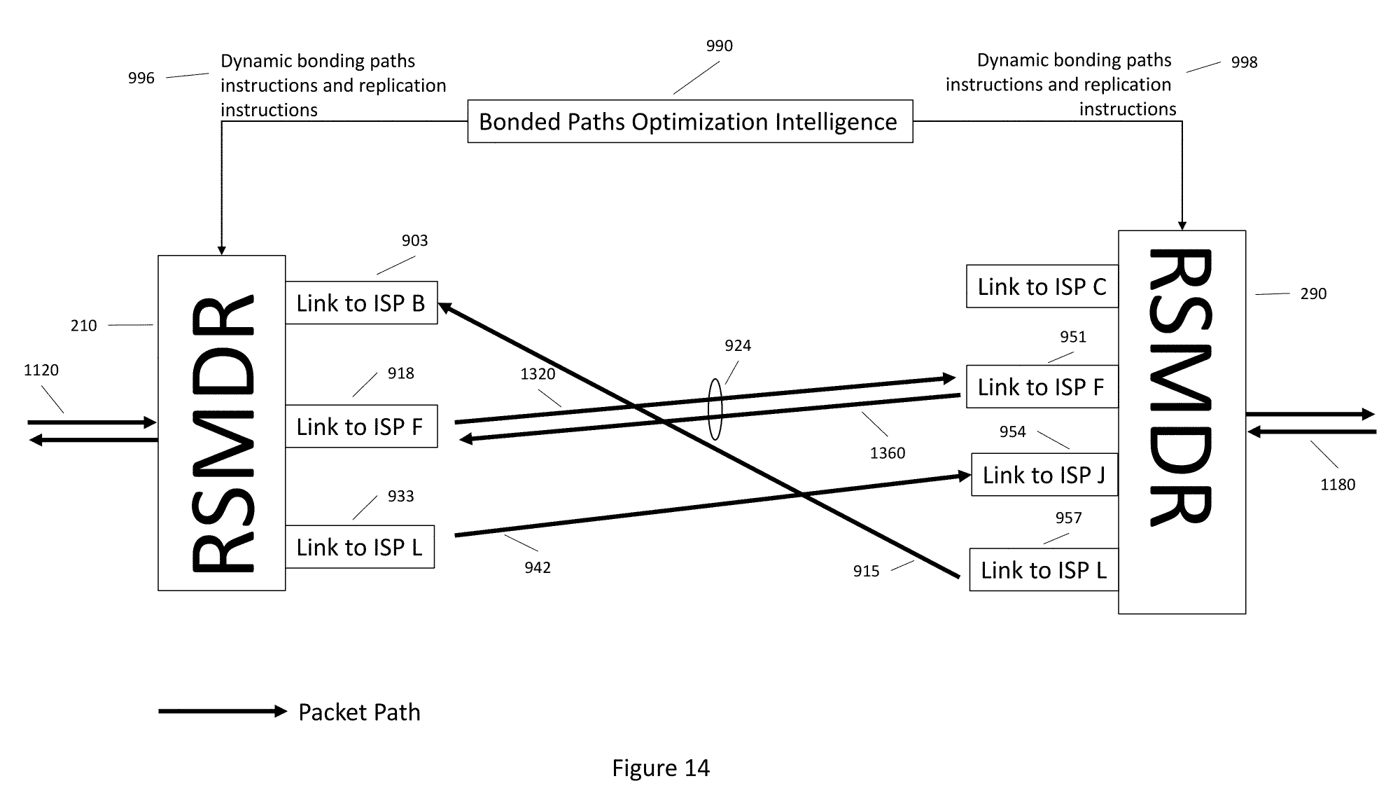

The set of bonded diverse replication paths between two RSMDRs may be composed of fully bi-directional paths, only unidirectional paths, or a combination of bi-directional and unidirectional paths as a function of what the Bonded Paths Optimization Intelligence deems to be the best per its evaluation criteria (e.g. quality target, cost control) at a given point in time for a given traffic type or group of traffic. In an embodiment illustrated by FIG. 14 one bi-directional path and two one way paths compose the set of bonded diverse replication paths per the control of Bonded Paths Optimization Intelligence 990 per its instructions 996 and 998. RSMDR 210 sends one replicant of traffic 1120 over direction 1320 within bi-directional path 924 from link 918 to RSMDR 290's link 951. RSMDR 210 sends another replicant of traffic 1120 over unidirectional path 942 between its link 993 and RSM DR 290's link 954. In the opposite direction RMSDR 290 sends one replicant of traffic 1180 over the bi-directional path 924 in the direction of 1360 from its link 951 to RSMDR 210's link 918. RMSDR 290 sends another replicant of traffic 1180 over its link 957 over the one-way path 915 to RSMDR 210's link 903.

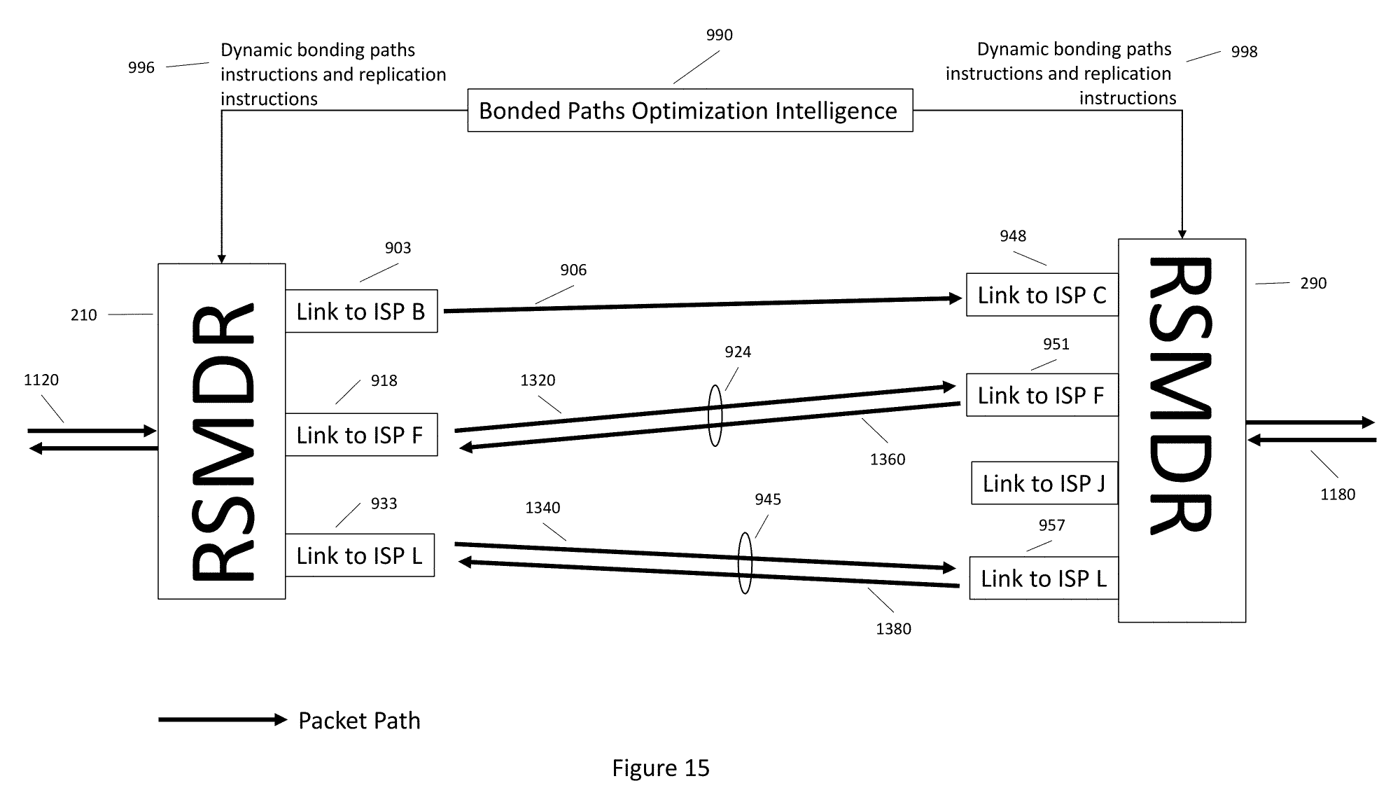

The number of paths and their direction type, unidirectional or bidirectional, and number of replicants and their allocation algorithm used by the set of bonded diverse replication paths between a RSM DR pair may vary by direction. In an embodiment illustrated by FIG. 15 the set of bonded diverse replication paths between RSMDR 210 and RSMDR 290 involve two bi-directional paths 924 and 945 and one unidirectional path 906. RSMDR 210 sends three replicants of traffic 1120 to RSMDR 290. One replicant goes over link 903 to link 948 over unidirectional path 906. A second replicant conveys over link 918 to bi-directional path 924 in direction 1320 to links 951. A third replicant conveys over bi-directional path 945 in the direction 1340 from link 933 to link 957. RMSDR 290 sends two replicants of traffic 1180 to RSMDR 210. One replicant conveys over link 951 through bi-directional path 924 in direction 1360 to link 918 whereas the other replicant conveys over link 957 through bi-directional path 945 in the direction 1380 to link 933.

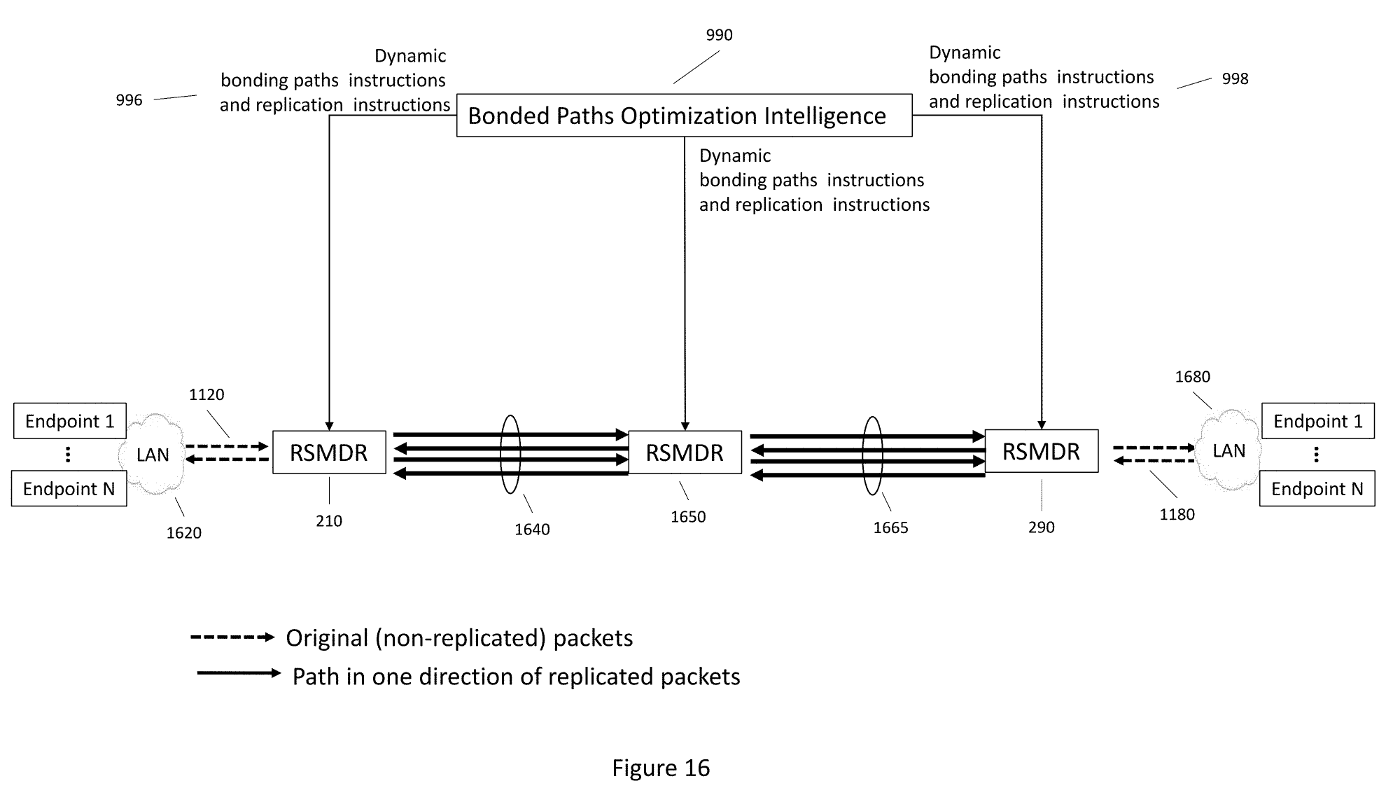

The end to end path in any one direction may span one or more contiguous bonded diverse replication paths thus the replication and deduplication of packets may take place at multiple RSMDRs along the end to end path thereby increasing the ability to minimize packet loss—the shorter the path between two RSMDRs reduces the probability that all bonded paths will lose the same packet. An intermediate RSMDR sitting between other RSMDRs will replicate traffic it sends to each RSMDR peer and merge the replicated traffic it receives from each RSMDR peer. In an embodiment illustrated by FIG. 16 three RSMDRs 210, 1650, and 290 under the control of the Bonded Paths Optimization Intelligence 990 replicates and merges packets over the end to end path between LANs 1620 and 1680. Traffic exchanged between LANs 1620 and 1680 involve the RSMDR 210 at the edge of LAN 1620, RSM DR 290 at the edge of LAN 1680, and RSMDR 1640 somewhere between RSMDRs 210 and 290.

RSM DR 210 replicates traffic 1120 over the bonded diverse replication paths 1640. RSMDR 1650 merges and deduplicates the received replicated traffic. RSMDR 1640 then replicates anew the traffic 1120 over bonded diverse replication paths 1665 towards RSMDR 290. The same happens in the opposite direction for traffic 1180. Not illustrated by FIG. 16, the number of replication paths taken by traffic 1120 and the amount of replication may vary between the bonded diverse replication paths 1640 and the bonded diverse replication paths 1665. Also not illustrated in FIG. 16, in the other direction the number of replication paths taken by traffic 1180 may also vary between the bonded diverse replication paths 1665 and the bonded diverse replication paths 1640.

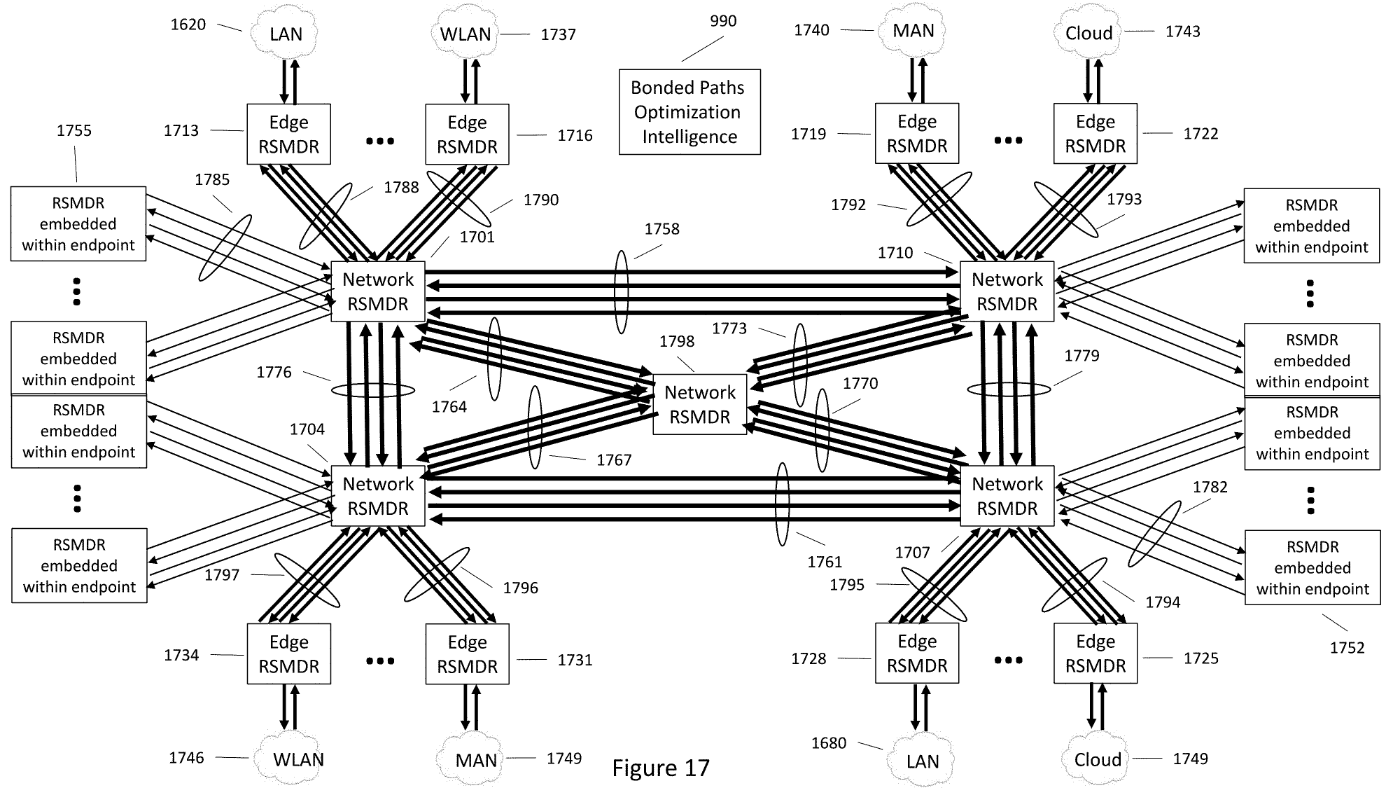

A group of RSMDRs may form a replication capable virtual network overlay potentially spanning multiple diverse networks, multiple diverse network types and multiple diverse transmission technologies. Edge RSMDRs sit at the edge of the LANs, WLANs, MANs, or Cloud associated data centers. RSMDR functionality may also be embedded into endpoints including but not limited to cell phones, tablets, and laptops. Many endpoints only have a single WAN access link. Some have more than one WAN access link but can only employ one WAN access link at a time. Some endpoints can employ two or more WAN access links simultaneously. The Bonded Paths Optimization Intelligence will take full advantage of such simultaneously available links. Other RSMDRs, Network RSMDRs, sit within the interior of the virtual network overlay. The end to end path of replicated communications over diverse bonded paths may involve two or more RSMDRs. An Edge RSMDR connects to at least one Network RSMDR. A Network RSMDR connects to one or more other Network RSMDRs. A Network RSM DR may also connect to one or more Edge RSMDRs and/or one or more RSMDRs embedded within endpoints. In an embodiment illustrated by FIG. 17 Network RSMDRs 1701, 1704, 1707, 1710, and 1798 compose a Virtual Network Overlay. These Network RSMDRs interconnect with each other over bonded diverse replication paths 1758, 1761, 1764, 1767, 1776, 1779, 1770, 1773. The Edge RSMDRs 1713, 1716, 1719, 1722, 1725, 1728, 1731, and 1734 along with RSMDRs embed within endpoints such as RSMDR 1752 and 1755 connect to the RSMDR network over bonded diverse replication paths 1782, 1785, 1788, 1790, 1792, 1793, 1794, 1795, 1796 and 1797. The Bonded Paths Optimization Intelligence 990 controls all these RSMDRs. Note that endpoints attached to LAN 1620 or 1680 or WLAN 1737 or 1746 or MAN 1740 or 1749 or Cloud data center 1743 or 1749 or endpoint with embedded RSM DR functionality such as 1752 and 1755 can communicate with each other by way of the previously mentioned bonded diverse replication paths. In a different embodiment one or more centralized Bonded Paths Optimization Intelligence functions could sit above the RSMDRs. At one point in time the communication between RSMDR embedded within an endpoint 1755 and Cloud 1749 may traverse Network RSMDR 1701, Network RSMDR 1798, and Network RSM DR 1707 but in response to congestion the Bonded Paths Optimization Intelligence may change the path such that it changes to spanning Network RSMDR 1701, Network RSMDR 1704, and Network RSM DR 1707. Also note that the optimum path may vary by direction. For instance, at a given point in time the optimal from the RSMDR embedded within an endpoint 1755 to Cloud 1749 may traverse Network RSMDR 1701, Network RSMDR 1798, and Network RSMDR 1707 whereas in the direction from Cloud 1749 to RSMDR embedded within an endpoint 1755 the optimal path may instead be RSMDR 1707, Network RSMDR 1710, and Network RSM DR 1701.

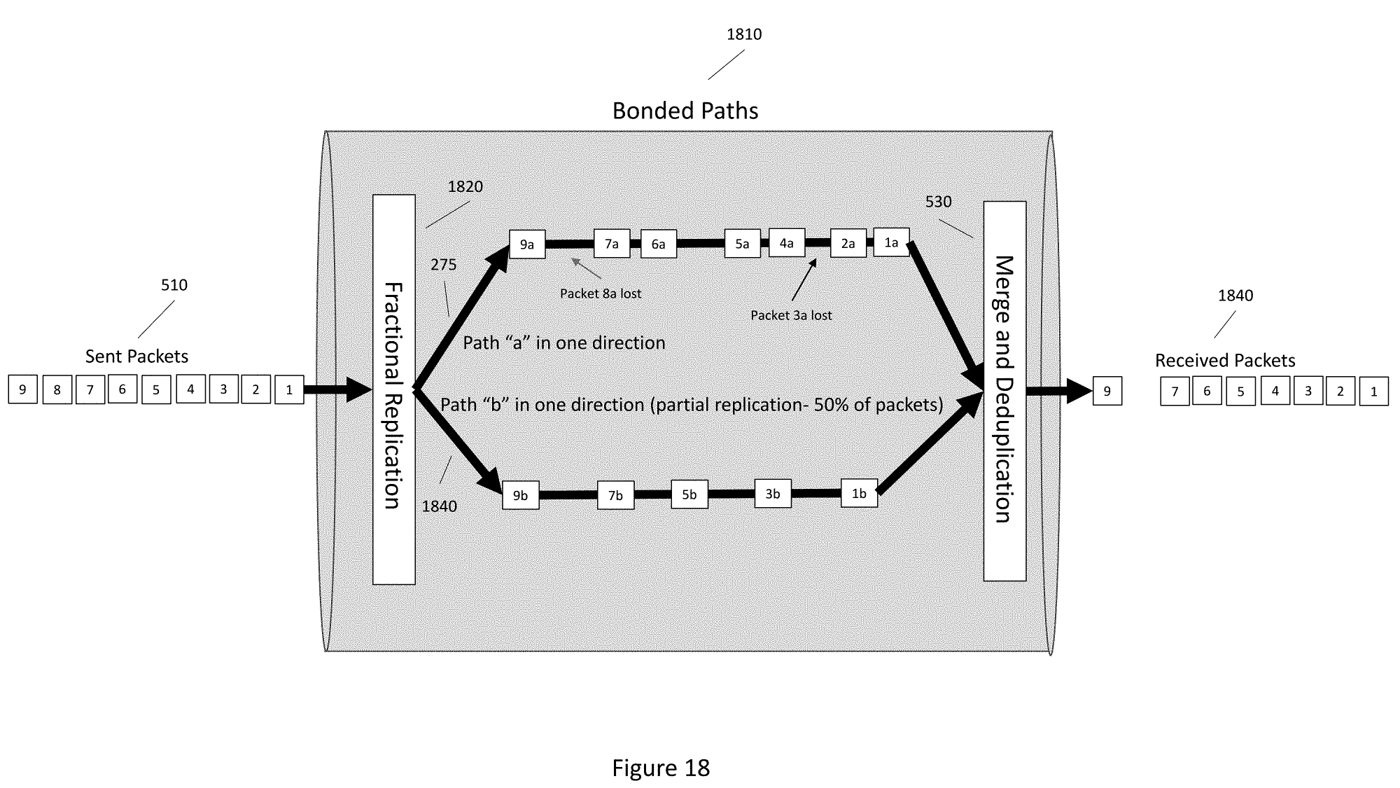

Since packet replication consumes additional bandwidth the ability to minimally replicate a portion of a communication's packets to meet a quality of service would minimize bandwidth usage. A path such as a cellular LTE based path may be metered. Partial packet replication may therefore provide a more cost effective means of meeting an acceptable quality of service. In an embodiment illustrated by FIG. 18 Fractional Replication function 1820 creates within the Bonded Paths 1810 one full replicant of packets 510 sent over path 275 but creates a partial replicant comprised of 50% of the packet 510, the odd numbered packets, for delivery over the path 1840. Along path 275 packets 8a and 3a are lost but no packets are lost along path 1840. The Merge and Deduplication function 530 yields the packets 1840 with a single lost packet. In this way Fractional Replication 1820 can meet a quality of service objective without having to completely replicate packets 510.

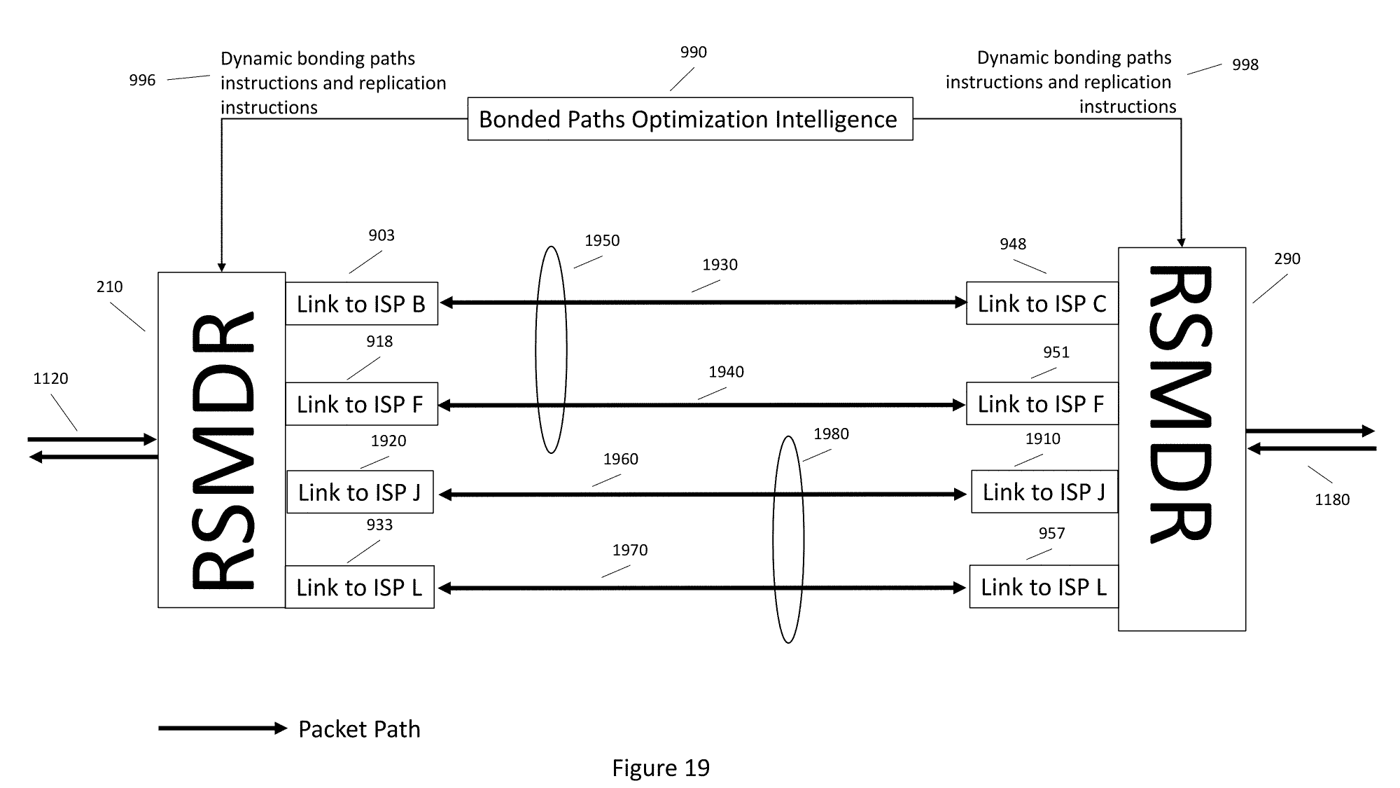

Two RSMDRs may jointly support two different sets of bonded diverse replication paths between each other. Different types of traffic may be conveyed over different sets of bonded diverse replication paths. In an example real-time traffic may convey over one set of bonded diverse replication paths and non-real-time traffic over a different set of bonded diverse replication paths. In an embodiment illustrated by FIG. 19 the traffic 1120 may be split by RSM DR 210 and traffic 1180 may be split by RSM DR 290 such that the real-time traffic subset conveys over ISP Links 903 and 918 to ISP links 948 and 951 over paths 1930 and 1940 within the bonded paths set 1950 whereas the non-real-time traffic subset conveys over ISP links 1920 and 933 to ISP links 1910 and 957 over paths 1960 and 1970 within the bonded paths set 1980.

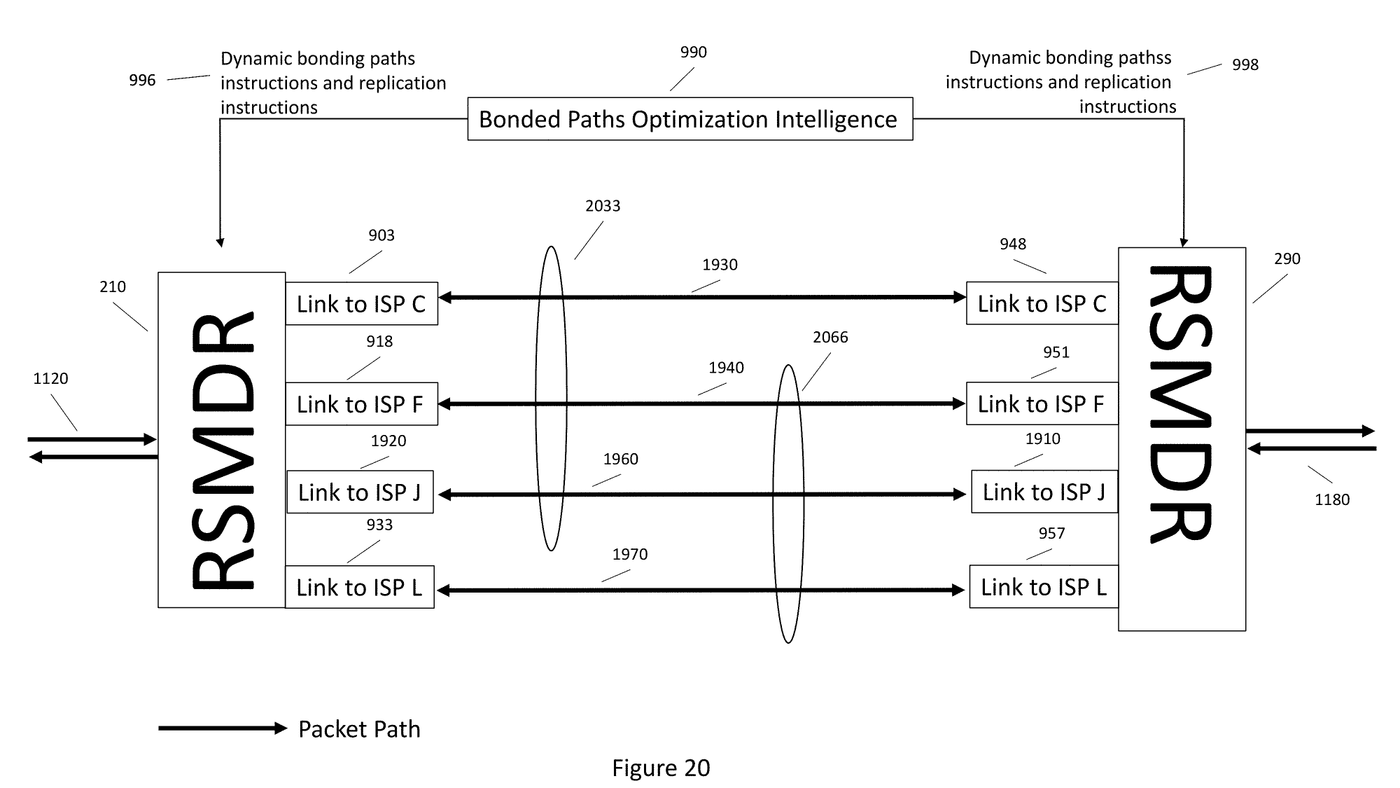

The two or more sets of bonded diverse replication paths may partially overlap with respect to their constituent paths. In an embodiment illustrated by FIG. 20 two sets of bonded diverse replication paths partially overlap. Subsets of traffic 1120 and 1180 convey over bonded paths 2033 or 2066. Note that bonded paths 2033 and 2066 partially overlap with regards to path 1940 between links 918 and 951 and path 1960 between links 1920 and 1910.

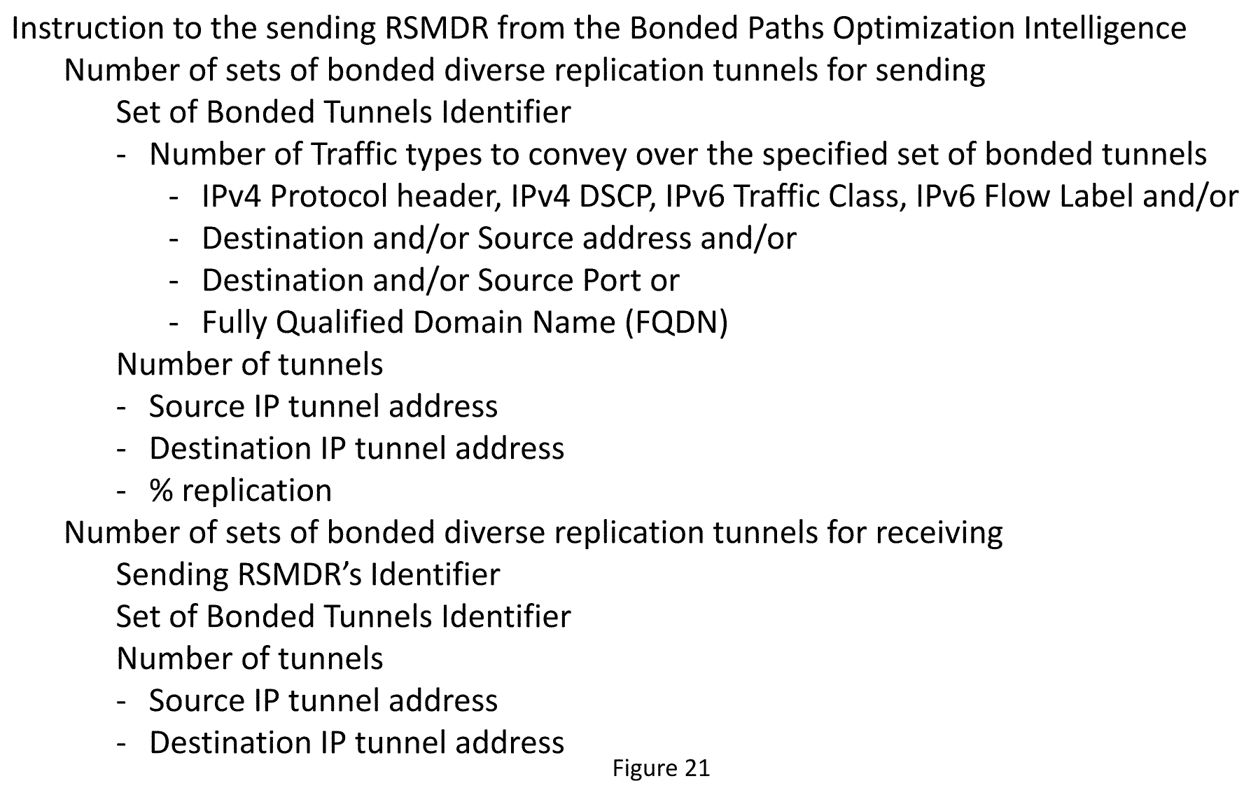

The Bonded Paths Optimization Intelligence control function instructs each RSM DR to construct one or more sending sets of bonded diverse replication paths and one or more receiving sets of bonded diverse replication paths. Each set comprises a list of bonded paths that carry common replicated traffic. The Bonded Paths Optimization Intelligence function specifies which specific type or types of traffic are to be conveyed over the set of bonded diverse replication sending paths. The Bonded Paths Optimization Intelligence control function will specify on a path by path basis within a given set the percentage of replication. A given path set at 100% replication would convey a complete replicant. A given path set at 50% replication would only convey half of a replicant (e.g. every other packet, random sampling of half the packets). A given path set to 300% would by itself convey three complete replicants. Replication above 100% is particularly applicable when both the sending and the receiving RSM DR each have but a single WAN access link. In an embodiment in the context of an IP tunneling based implementation illustrated by FIG. 21 the Bonded Paths Optimization Intelligence function instructs a RSMDR to construct one or more sending sets of bonded diverse replication tunnels and how to use these bonded tunnel sets. The “Number of sets of bonded diverse replication tunnels” specifies the number of to be bonded sending tunnels. Each set of bonded tunnels is given a unique identifier—the “Set of Bonded Tunnels Identifier”. Recall that the “Set of Boned Tunnels Identifier” is also found in FIG. 3 section 320. Each set of bonded diverse replication tunnels has two arrays of further instruction. The number of array entries for the first array is specified by the “Number of Traffic types to convey over the specified set of bonded tunnels”. Then the type or type of traffics to be conveyed is specified. The traffic may be identified by some subset combination of “IPv4 Protocol Header”, “IPv4 DSCP”, “IPv6 Traffic Class”, “IPv6 Flow Label”, “Destination and/or Source address”, “Destination and/or Source Port”, and “Fully Qualified Domain Name (FQDN)”. The number of array entries for the second array is specified by the “Number of tunnels”. The “Source IP tunnel address” and “Destination IP tunnel address” specifies the IP tunnel. Note that section 310 within encapsulating packet 260 in FIG. 3 is associated with one of these tunnels. The individual tunnel is also assigned a “% replication” factor. This Bonded Paths Optimization Intelligence instruction to the RSM DR also specifies further down one or more sets of bonded diverse replication tunnels for receiving. Recall that the “Sending RMSDR's Identifier” and the “Set of Boned Tunnels Identifier” are also found in FIG. 3 section 320. Note that for a Network RSMDR this instruction specifies sending and receiving sets of bonded replication paths spanning both of its sides.

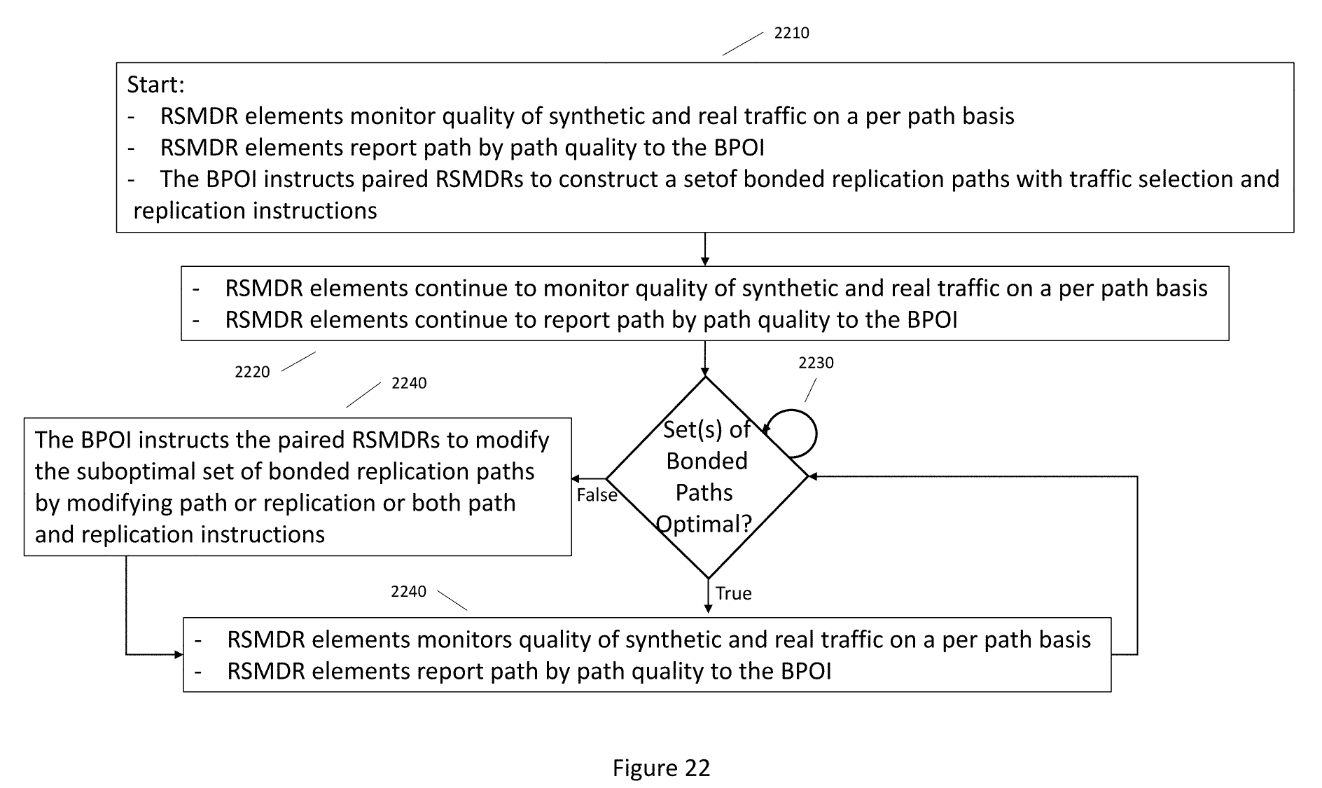

A finite state machine governs the integrated behavior spanning the Bonded Paths Optimization Intelligence (BPOI) and the elements with the RSM DR functions it controls. Although steps are depicted as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways. In an embodiment illustrated by FIG. 22 the description a very high level finite state machine starts with step 2210. Each element with a RSMDR function monitors the quality of synthetic and real traffic received from another element with a RSMDR function on a path by path basis-both employed paths carrying real traffic an unemployed path carrying synthetic traffic. This information is reported to the BPOI function. The BPOI function instructs the RSMDR pairs to construct one set of bonded replication paths with traffic selection and replication instructions. The possible algorithms for path selection, traffic selection, and replication instructions are innumerable. In one example the selected traffic may be only real-time voice and video streams. The two paths with the lowest packet loss rate may be selected as bonded bi-directional paths. A replicant of the voice and video traffic in each direction may be conveyed over each path. The monitoring of the quality of all the paths and the reporting of this information to the BPOI continues as per steps 2220. On a recurrent timer expiration basis 2230 the current set or sets of bonded replication paths are compared to the quality monitoring of all paths. If the set of bonded paths is not optimal in one or both directions, the selected paths for that direction or directions are changed in step 2240. The finite state machine awaits anew for the timer 2230 to fire again and then the finite state machine continues as previously described. Note that a severed path would be monitored as having a 100% packet loss rate. In a slightly more complex embodiment the BPOI may be provisioned to meet a minimal post merge packet loss rate. In this embodiment assume the selection algorithm in steps 2210 and 2240 may permit the use of up to 3 paths in a given direction. Assume that packet loss is random. Assume that the top three paths in terms of quality in a given direction per monitoring are suffering from packet loss rates of 10%, 20% and 30% respectively. Assume that the acceptable packet loss rate limit is 1%. The best two bonded paths would yield a post merge packet loss rate of 10% times 20% equal to 2%. This packet loss rate is unacceptable. By the addition of the 3^{rd} bonded path by the BPOI the post merge packet loss rate would be 10% times 20% times 30% equal to 0.6% which meets the criteria of a packet loss rate below 1%. If the third path has metered usage a partial replication across this metered path would enable the meeting of the quality objective while also reducing the metered usage.

If an element with the RSMDR function and with only a single WAN access link replicates traffic with another element with the RSMDR function also with only a single WAN access link, replication is likely to be of some benefit so long as not all of the traffic is replicated and so long as the replicated traffic is given preferential treatment such as by Differentiated Services (DiffServ) or Integrated Services (IntServ) where the prioritized traffic is favored. Otherwise the replicated traffic will add to the network congestion such that this congestion impacts the replicated traffic. The use of DiffSery or IntSent or functionally similar technology would protect the prioritized replicated traffic at the expense of all other traffic. If congestion results in a 10% packet loss rate, duplicating favored replicated traffic would reduce the packet loss rate to approximately 5%.

Note that a pair of endpoints or a pair of edge elements or a pair of endpoint and edge element each with the RSMDR function may share one or more sets of bonded paths.

Note that the payload of the bonded packet paths, the original packets, may be encrypted as typically done by encrypting virtual private networks such as the IETF specified IPSec in tunnel mode.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

### 2. Networking Hardware Overview

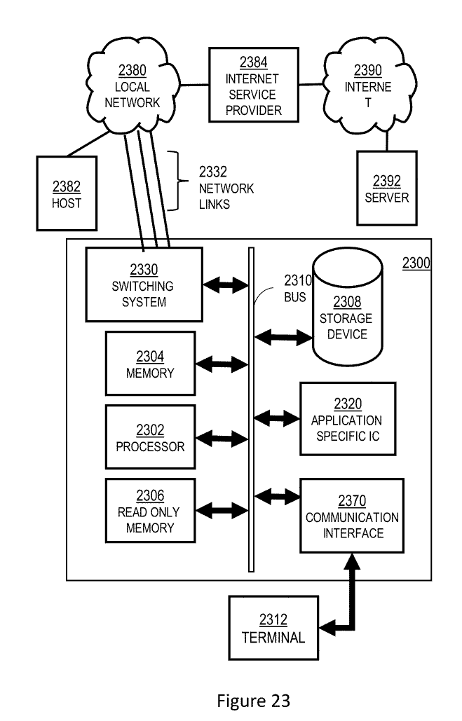

FIG. 23 is a block diagram that illustrates a computer system 2300 upon which an embodiment of the invention may be implemented. Computer system 2300 includes a communication mechanism such as a bus 2310 for passing information between other internal and external components of the computer system 2300. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 2300, or a portion thereof, constitutes a means for performing one or more steps of one or more methods described herein.

A sequence of binary digits constitutes digital data that is used to represent a number or code for a character. A bus 2310 includes many parallel conductors of information so that information is transferred quickly among devices coupled to the bus 2310. One or more processors 2302 for processing information are coupled with the bus 2310. A processor 2302 performs a set of operations on information. The set of operations include bringing information in from the bus 2310 and placing information on the bus 2310. The set of operations also typically include comparing two or more units of information, shifting positions of units of information, and combining two or more units of information, such as by addition or multiplication. A sequence of operations to be executed by the processor 2302 constitutes computer instructions.

Computer system 2300 also includes a memory 2304 coupled to bus 2310. The memory 2304, such as a random access memory (RAM) or other dynamic storage device, stores information including computer instructions. Dynamic memory allows information stored therein to be changed by the computer system 2300. RAM allows a unit of information stored at a location called a memory address to be stored and retrieved independently of information at neighboring addresses. The memory 2304 is also used by the processor 2302 to store temporary values during execution of computer instructions. The computer system 2300 also includes a read only memory (ROM) 2306 or other static storage device coupled to the bus 2310 for storing static information, including instructions, that is not changed by the computer system 2300. Also coupled to bus 2310 is a non-volatile (persistent) storage device 2308, such as a magnetic disk, optical disk, or FLASH-EPROM, for storing information, including instructions, that persists even when the computer system 2300 is turned off or otherwise loses power.

Information, including instructions, is provided to the bus 2310 for use by the processor from an external input device 2312, such as a keyboard containing alphanumeric keys operated by a human user, or a sensor. A sensor detects conditions in its vicinity and transforms those detections into signals compatible with the signals used to represent information in computer system 2300. Other external devices coupled to bus 2310, used primarily for interacting with humans, include a display device 2314, such as a cathode ray tube (CRT) or a liquid crystal display (LCD), for presenting images, and a pointing device 2316, such as a mouse or a trackball or cursor direction keys, for controlling a position of a small cursor image presented on the display 2314 and issuing commands associated with graphical elements presented on the display 2314.

In the illustrated embodiment, special purpose hardware, such as an application specific integrated circuit (IC) 2320, is coupled to bus 2310. The special purpose hardware is configured to perform operations not performed by processor 2302 quickly enough for special purposes. Examples of application specific ICs include graphics accelerator cards for generating images for display 2314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

In the illustrated computer used as a router, the computer system 2300 includes switching system 2330 as special purpose hardware for switching information flow over a network. Switching system 2330 typically includes multiple communications interfaces, such as communications interface 2370, for coupling to multiple other devices. In general, each coupling is with a network link 2332 that is connected to another device in or attached to a network, such as local network 2380 in the illustrated embodiment, to which a variety of external devices with their own processors are connected. In some embodiments an input interface or an output interface or both are linked to each of one or more external network elements. Although three network links 2332a, 2332b, 2332c are included in network links 2332 in the illustrated embodiment, in other embodiments, more or fewer links are connected to switching system 2330. Network links 2332 typically provides information communication through one or more networks to other devices that use or process the information. For example, network link 2332b may provide a connection through local network 2380 to a host computer 2382 or to equipment 2384 operated by an Internet Service Provider (ISP). ISP equipment 2384 in turn provides data communication services through the public, world-wide packet-switching communication network of networks now commonly referred to as the Internet 2390. A computer called a server 2392 connected to the Internet provides a service in response to information received over the Internet. For example, server 2392 provides routing information for use with switching system 2330.

The switching system 2330 includes logic and circuitry configured to perform switching functions associated with passing information among elements of network 2380, including passing information received along one network link, e.g. 2332a, as output on the same or different network link, e.g., 2332c. The switching system 2330 switches information traffic arriving on an input interface to an output interface according to pre-determined protocols and conventions that are well known. In some embodiments, switching system 2330 includes its own processor and memory to perform some of the switching functions in software. In some embodiments, switching system 2330 relies on processor 2302, memory 2304, ROM 2306, storage 2308, or some combination, to perform one or more switching functions in software. For example, switching system 2330, in cooperation with processor 2304 implementing a particular protocol, can determine a destination of a packet of data arriving on input interface on link 2332a and send it to the correct destination using output interface on link 2332c. The destinations may include host 2382, server 2392, other terminal devices connected to local network 2380 or Internet 2390, or other routing and switching devices in local network 2380 or Internet 2390.

Computer system 2300 also includes one or more instances of a communications interface 2370 coupled to bus 2310. Communication interface 2370 provides a two-way communication coupling to a variety of external devices that operate with their own processors, such as printers, scanners and external disks. In general the coupling is with a network link 2332 that is connected to a local network 2380 to which a variety of external devices with their own processors are connected. For example, communication interface 2370 may be a parallel port or a serial port or a universal serial bus (USB) port on a personal computer. In some embodiments, communications interface 2370 is an integrated services digital network (ISDN) card or a digital subscriber line (DSL) card or a telephone modem that provides an information communication connection to a corresponding type of telephone line. In some embodiments, a communication interface 2370 is a cable modem that converts signals on bus 2310 into signals for a communication connection over a coaxial cable or into optical signals for a communication connection over a fiber optic cable. As another example, communications interface 2370 may be a local area network (LAN) card to provide a data communication connection to a compatible LAN, such as Ethernet. As another example, communications interface 2370 may be a modulator-demodulator (modem) to provide a wireless link to other devices capable of receiving information wirelessly. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 2370 sends and receives electrical, acoustic or electromagnetic signals, including infrared and optical signals, that carry information streams, such as digital data.

The term computer-readable medium is used herein to refer to any medium that participates in providing information to processor 2302, including instructions for execution. Such a medium may take many forms, including, but not limited to, non-volatile media, volatile media and transmission media. Non-volatile media include, for example, optical or magnetic disks, such as storage device 2308. Volatile media include, for example, dynamic memory 2304. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 2302, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 2302, except for carrier waves and other signals.

Logic encoded in one or more tangible media includes one or both of processor instructions on a computer-readable storage media and special purpose hardware, such as ASIC 2320.

The invention is related to the use of computer system 2300 for implementing the techniques described herein. According to one embodiment of the invention, those techniques are performed by computer system 2300 in response to processor 2302 executing one or more sequences of one or more instructions contained in memory 2304. Such instructions, also called software and program code, may be read into memory 2304 from another computer-readable medium such as storage device 2308. Execution of the sequences of instructions contained in memory 2304 causes processor 2302 to perform the method steps described herein. In alternative embodiments, hardware, such as application specific integrated circuit 2320, may be used in place of or in combination with software to implement the invention. Thus, embodiments of the invention are not limited to any specific combination of hardware and software.

The signals transmitted over network link 2332 and other networks through communications interface 2370, carry information to and from computer system 2300. Computer system 2300 can send and receive information, including program code, through the networks 2380, 2390 among others, through network link 2332 and communications interface 2370. In an example using the Internet 2390, a server 2392 transmits program code for a particular application, requested by a message sent from computer 2300, through Internet 2390, ISP equipment 2384, local network 2380 and communications interface 2370. The received code may be executed by processor 2302 as it is received, or may be stored in storage device 2308 or other non-volatile storage for later execution, or both. In this manner, computer system 2300 may obtain application program code in the form of a signal on a carrier wave.

Various forms of computer readable media may be involved in carrying one or more sequence of instructions or data or both to processor 2302 for execution. For example, instructions and data may initially be carried on a magnetic disk of a remote computer such as host 2382. The remote computer loads the instructions and data into its dynamic memory and sends the instructions and data over a telephone line using a modem. A modem local to the computer system 2300 receives the instructions and data on a telephone line and uses an infra-red transmitter to convert the instructions and data to a signal on an infra-red a carrier wave serving as the network link 2332. An infrared detector serving as communications interface 2370 receives the instructions and data carried in the infrared signal and places information representing the instructions and data onto bus 2310. Bus 2310 carries the information to memory 2304 from which processor 2302 retrieves and executes the instructions using some of the data sent with the instructions. The instructions and data received in memory 2304 may optionally be stored on storage device 2308, either before or after execution by the processor 2302.

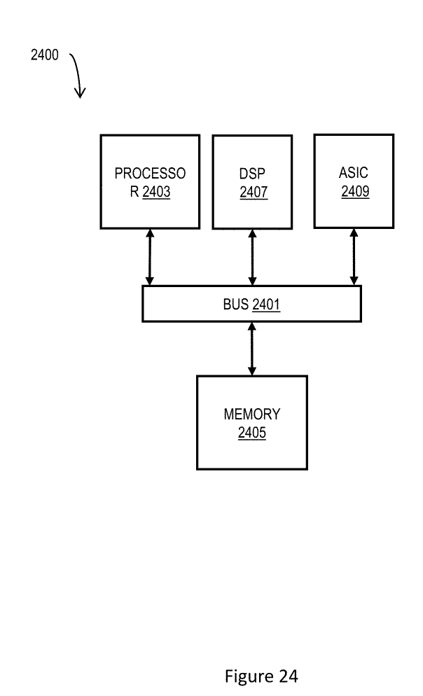

FIG. 24 illustrates a chip set 2400 upon which an embodiment of the invention may be implemented. Chip set 2400 is programmed to perform one or more steps of a method described herein and includes, for instance, the processor and memory components described with respect to FIG. 23 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 2400, or a portion thereof, constitutes a means for performing one or more steps of a method described herein.

In one embodiment, the chip set 2400 includes a communication mechanism such as a bus 2401 for passing information among the components of the chip set 2400. A processor 2403 has connectivity to the bus 2401 to execute instructions and process information stored in, for example, a memory 2405. The processor 2403 may include one or more processing cores with each core configured to perform independently. A multi-core processor enables multiprocessing within a single physical package. Examples of a multi-core processor include two, four, eight, or greater numbers of processing cores. Alternatively or in addition, the processor 2403 may include one or more microprocessors configured in tandem via the bus 2401 to enable independent execution of instructions, pipelining, and multithreading. The processor 2403 may also be accompanied with one or more specialized components to perform certain processing functions and tasks such as one or more digital signal processors (DSP) 2407, or one or more application-specific integrated circuits (ASIC) 2409. A DSP 2407 typically is configured to process real-world signals (e.g., sound) in real time independently of the processor 2403. Similarly, an ASIC 2409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 2403 and accompanying components have connectivity to the memory 2405 via the bus 2401. The memory 2405 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 2405 also stores the data associated with or generated by the execution of one or more steps of the methods described herein.

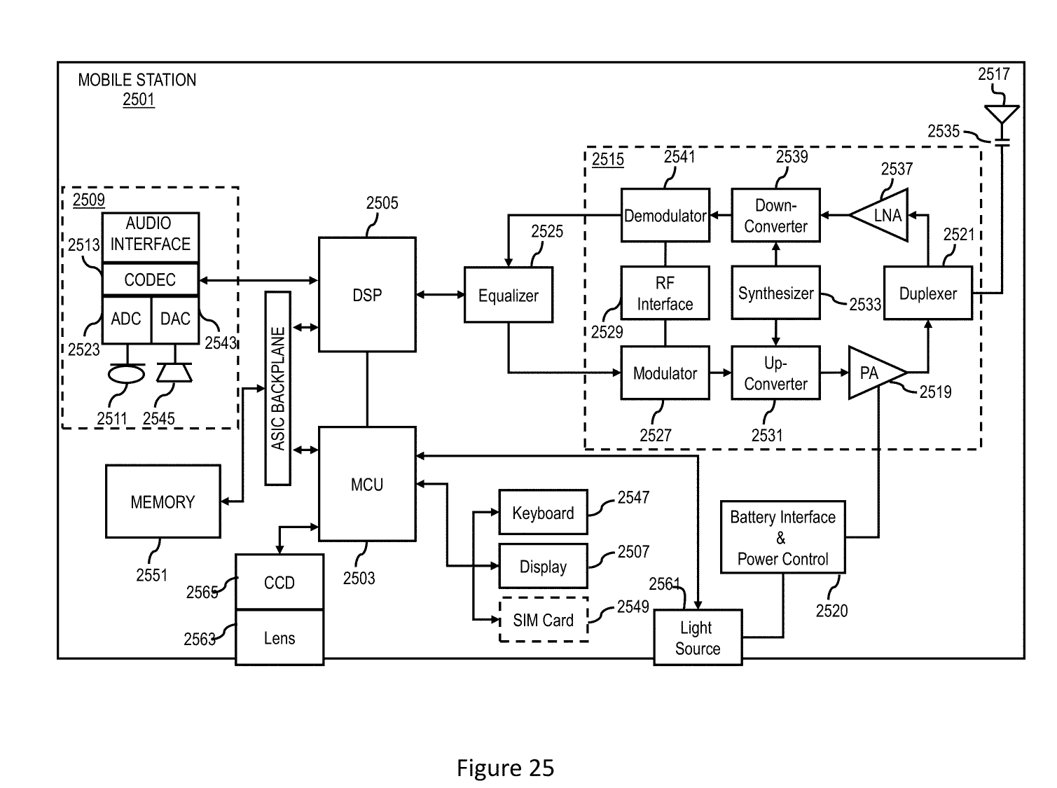

FIG. 25 is a diagram of exemplary components of a mobile terminal 2500 (e.g., cell phone handset) for communications. In some embodiments, mobile terminal 2501, or a portion thereof, constitutes a means for performing one or more steps described herein. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 2503, a Digital Signal Processor (DSP) 2505, and a receiver/transmitter unit including a microphone gain control unit and a speaker gain control unit. A main display unit 2507 provides a display to the user in support of various applications and mobile terminal functions that perform or support the steps as described herein. The display 2507 includes display circuitry configured to display at least a portion of a user interface of the mobile terminal (e.g., mobile telephone). Additionally, the display 2507 and display circuitry are configured to facilitate user control of at least some functions of the mobile terminal. An audio function circuitry 2509 includes a microphone 2511 and microphone amplifier that amplifies the speech signal output from the microphone 2511. The amplified speech signal output from the microphone 2511 is fed to a coder/decoder (CODEC) 2513.

A radio section 2515 amplifies power and converts frequency in order to communicate with a base station, which is included in a mobile communication system, via antenna 2517. The power amplifier (PA) 2519 and the transmitter/modulation circuitry are operationally responsive to the MCU 2503, with an output from the PA 2519 coupled to the duplexer 2521 or circulator or antenna switch, as known in the art. The PA 2519 also couples to a battery interface and power control unit 2520.

In use, a user of mobile terminal 2501 speaks into the microphone 2511 and his or her voice along with any detected background noise is converted into an analog voltage. The analog voltage is then converted into a digital signal through the Analog to Digital Converter (ADC) 2523. The control unit 2503 routes the digital signal into the DSP 2505 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 2525 for compensation of any frequency-dependent impairments that occur during transmission though the air such as phase and amplitude distortion. After equalizing the bit stream, the modulator 2527 combines the signal with a RF signal generated in the RF interface 2529. The modulator 2527 generates a sine wave by way of frequency or phase modulation. In order to prepare the signal for transmission, an up-converter 2531 combines the sine wave output from the modulator 2527 with another sine wave generated by a synthesizer 2533 to achieve the desired frequency of transmission. The signal is then sent through a PA 2519 to increase the signal to an appropriate power level. In practical systems, the PA 2519 acts as a variable gain amplifier whose gain is controlled by the DSP 2505 from information received from a network base station. The signal is then filtered within the duplexer 2521 and optionally sent to an antenna coupler 2535 to match impedances to provide maximum power transfer. Finally, the signal is transmitted via antenna 2517 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 2501 are received via antenna 2517 and immediately amplified by a low noise amplifier (LNA) 2537. A down-converter 2539 lowers the carrier frequency while the demodulator 2541 strips away the RF leaving only a digital bit stream. The signal then goes through the equalizer 2525 and is processed by the DSP 2505. A Digital to Analog Converter (DAC) 2543 converts the signal and the resulting output is transmitted to the user through the speaker 2545, all under control of a Main Control Unit (MCU) 2503 which can be implemented as a Central Processing Unit (CPU) (not shown).

The MCU 2503 receives various signals including input signals from the keyboard 2547. The keyboard 2547 and/or the MCU 2503 in combination with other user input components (e.g., the microphone 2511) comprise a user interface circuitry for managing user input. The MCU 2503 runs a user interface software to facilitate user control of at least some functions of the mobile terminal 2501 as described herein. The MCU 2503 also delivers a display command and a switch command to the display 2507 and to the speech output switching controller, respectively. Further, the MCU 2503 exchanges information with the DSP 2505 and can access an optionally incorporated SIM card 2549 and a memory 2551. In addition, the MCU 2503 executes various control functions required of the terminal. The DSP 2505 may, depending upon the implementation, perform any of a variety of conventional digital processing functions on the voice signals. Additionally, DSP 2505 determines the background noise level of the local environment from the signals detected by microphone 2511 and sets the gain of microphone 2511 to a level selected to compensate for the natural tendency of the user of the mobile terminal 2501.

The CODEC 2513 includes the ADC 2523 and DAC 2543. The memory 2551 stores various data including call incoming tone data and is capable of storing other data including music data received via, e.g., the global Internet. The software module could reside in RAM memory, flash memory, registers, or any other form of writable storage medium known in the art. The memory device 2551 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 2549 carries, for instance, important information, such as the cellular phone number, the carrier supplying service, subscription details, and security information. The SIM card 2549 serves primarily to identify the mobile terminal 2501 on a radio network. The card 2549 also contains a memory for storing a personal telephone number registry, text messages, and user specific mobile terminal settings.

In some embodiments, the mobile terminal 2501 includes a digital camera comprising an array of optical detectors, such as charge coupled device (CCD) array 2565. The output of the array is image data that is transferred to the MCU for further processing or storage in the memory 2551 or both. In the illustrated embodiment, the light impinges on the optical array through a lens 2563, such as a pin-hole lens or a material lens made of an optical grade glass or plastic material. In the illustrated embodiment, the mobile terminal 2501 includes a light source 2561, such as a LED to illuminate a subject for capture by the optical array, e.g., CCD 2565. The light source is powered by the battery interface and power control module 2520 and controlled by the MCU 2503 based on instructions stored or loaded into the MCU 2503.

### 4. Alternations, Deviations, Modifications

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

What is claimed is:

1) A network or a virtual network overlay administered by a control function with reachability and quality monitoring information input and optionally path cost information input that dynamically optimizes the selection of bonded communications paths, optionally subject to cost constraints, between replication sender and merge and deduplication receiver elements and that also dynamically optimizes the replication instructions to the sending elements for replicating packet communications of selected traffic over the bonded paths to dynamically and optimally improve the quality and availability of the selected communications.

2) The system in claim 1, wherein bonded paths within the network or virtual network are diverse.

3) The system of claim 1, wherein the virtual network overlay spans multiple network providers.

4) The system of claim 1, wherein the networks underlying the virtual network overlay spans multiple network technologies.

5) The system of claim 1, wherein the control function may be centralized and remote from or locally resident at the replication sender and merge and deduplication receiver function or a combination thereof.

6) The system of claim 1, wherein the traffic with one or more specific attributes, or the sender or senders, or sender with one or more specific attributes or senders with one or more specific attributes, or the receiver or the receivers, or the receiver with one or more specific attributes or receivers with one or more specific attributes, or combinations thereof determines which specific sent packets convey through a set of bonded paths and if sent through a set of bonded paths the associated replication instructions.

7) The system of claim 1, wherein a given replication sender and merge and deduplication receiver function resides within a sending endpoint, a receiving endpoint, an element at the edge of the sender's location, an element at the edge of the receiver's location, an intermediate network element, or an intermediate virtual network overlay element.

8) The system of claim 1, including the steps of:
generating synthetic packet traffic across some or all the links between pairs of replication sender and merge and deduplication receiver elements that exchange replicated traffic;
monitoring this synthetic packet traffic to evaluate path availability and path quality per packet communication quality assessment metrics;
using the available paths with the best quality, optionally subject to cost considerations, as the basis for creating one or more sets of bonded paths;
selecting traffic for traffic replication over a set of bonded different;
specifying packet replication instructions per bonded path regarding the number of replicants or percentage of replication, the latter potentially being a partial replicant used as a means of achieving a certain level of quality without having to take the capacity to support a full replication;
dynamically and autonomously modifying the set of bonded paths to maintain optimal quality and availability.

9) The system in claim 1, a virtual network overlay may span one or more Wide Area Networks (WANs), Local Area Networks (LANs), Wireless LANs (WLANs), Wireless WANs (WWANs), Metropolitan Area Networks (MANs), Mobile Ad Hoc Networks (MANETs), Satellite Networks, Radio Access Networks (RANs) any other type of network, or hybrid network (e.g. wired and wireless).

10) The system in claim 1, wherein the bonded paths are encrypted for security.

11) The system in claim 1, wherein the network or virtual network overlay conveys any and all types of packet-based services including but not necessarily limited to real-time interactive full duplex voice and video, broadcast audio and video, streaming audio and video, machine to machine communications, Internet of Things (IoT) communications, telemetry, and data communications.

12) The system in claim 1, wherein quality assessment may include but not necessarily be limited to packet loss rate, latency, and jitter and associated composite metrics.

13) The system of claim 5, wherein the control function when remote from the replication sender and merge and deduplication receiver element exists as two or more instances for reasons of high availability and scaling.

14) The system in claim 7, wherein an edge replication sender and merge and deduplication receiver function may reside within an edge element of any of various local networks including but not necessarily limited to local area networks (LANs), wireless LANs (WLANs), metropolitan area networks (MANs), Radio Access Networks (RANs), Satellite networks, cloud computing data centers, or cloud computing storage data centers.

15) The system in claim 7, wherein a replication sender and merge and deduplication receiver function may be embedded within an endpoint.

16) The system in claim 7, wherein a replication sender and merge and deduplication receiver function may be within a network or interior virtual overlay network element that may connect to other network or virtual network overlay elements with a replication sender and merge and deduplication receiver function and possibly edge elements with replication sender and merge and deduplication receiver function and possibly endpoints with embedded replication sender and merge and deduplication receiver function.

17) The system in claim 7, wherein a pair of endpoints or pair of edge elements or pair of an endpoint and an edge element each with the RSMDR function can directly establish with each other bonded paths.

18) The system in claim 7, wherein a plurality of directly or indirectly interconnected elements each with the replication sender and merge and deduplication receiver function under the control of a common bonded replication paths control function form a network or a single virtual network overlay.

19) The system in claim 7, wherein network or virtual network overlay elements containing the replication sender and merge and deduplication receiver function may also used by the control function as steering points to navigate traffic around geographic specific congestion.

20) The system in claim 8, wherein the paths within a set of bonded paths span more than one network.

21) The system in claim 8, wherein bonded paths within a set of bonded paths may span more than one provider.

22) The system in claim 8, wherein bonded paths within a set of bonded paths span different network technologies.

23) The system in claim 8, wherein a given bonded packet path may be unidirectional or bidirectional.

24) The system in claim 8, wherein the packets conveyed over a given set of bonded paths contain the sending replication sender and merge and deduplication receiver element's identifier, the identifier for the given set of bonded paths, and the packet sequence numbers such that all replicants of a given original packet share the same packet sequence number value and thus the trio combination of sending replication sender and merge and deduplication receiver element's identifier, the set of bonded paths identifier, and packet sequence number are used to merge and correctly order the received replicated packets and to then identify and drop the duplicated received packets.

25) The system in claim 8, wherein each replication sender and merge and deduplication receiver element may connect to one or more sets of bonded paths connecting with one or more other replication sender and merge and deduplication receiver elements.

26) The system in claim 8, wherein a given packet lost in one bonded path such loss would be eliminated by the presence of the same replicated packet in a different path within the same set of bonded paths.

27) The system in claim 8, wherein latency reduced by the destination playing the first received packet of a given packet's replicants.

28) The system in claim 8, wherein the severing of one or more bonded paths within a set of bonded paths does not materially impact service so long as there is at least one remaining viable bonded path carrying a full replicant of traffic within the set of bonded paths.

29) The system in claim 8, wherein replication may be duplication, triplication or n number of replications where n may be a whole number or some fraction greater than 1.

30) The system in claim 8, wherein within a set of bonded paths in a given direction a given replicant instance may employ a single path within a bonded paths set or may be fragmented across two or more paths within a set of bonded paths.

31) The system in claim 8, wherein replication in one direction may take place over a single path.

32) The system in claim 8, wherein from one side of the set of bonded diverse replication paths a single WAN access link may span two or more paths.

33) The system in claim 8, wherein replication within a set of bonded paths both locations use the same number of network links for sending and receiving replicated packets.

34) The system in claim 8, wherein within a set of bonded paths may involve both unidirectional and bi-directional paths.

35) The system in claim 8, wherein the number of employed paths and the replication instructions used by a set of bonded paths may vary by direction.

36) The system in claim 8, wherein two replication sender and merge and deduplication receiver elements establish between them two or more sets of bonded paths where each set conveys traffic designated for the particular set.

37) The system in claim 8, wherein on the two ends of a set of bonded paths may involve a different number of network links.

38) The system in claim 8, wherein the number of full and partial replicants may equal the number of bonded paths or alternately the number of full and partial replicants may be greater than the number of bonded paths or alternately the number of full and partial replicants may be less than the number of bonded paths.

39) The system in claim 8, wherein two or more sets of bonded paths connecting two replication send and merge and deduplication elements may have one or more overlapping bonded paths.
